(19) United States
(12) Patent Application Publication
(10) Pub. No.: US 2026/0341781 A1
(43) Pub. Date: Oct. 29, 2026

(54) SOLID ELECTROLYTE, SOLID ELECTROLYTE LAYER, AND SOLID ELECTROLYTE BATTERY

(71) Applicant: TDK Corporation, Tokyo (JP)

(72) Inventors: Masato KURIHARA, Tokyo (JP); Shota SATO, Tokyo (JP); Tetsuya UENO, Tokyo (JP); Hisashi SUZUKI, Tokyo (JP)

(73) Assignee: TDK Corporation, Tokyo (JP)

(21) Appl. No.: 19/114,937

(22) PCT Filed: Sep. 12, 2023
(86) PCT No.: PCT/JP2023/033167

§ 371 Date: Mar. 25, 2025

(30) Foreign Application Priority Data
Sep. 30, 2022 (JP) 2022-157983

(51) Int. Cl. H01M 10/0562; H01M 10/0525

(52) U.S. Cl. CPC H01M 10/0562; H01M 10/0525; H01M 2300/008

(57) ABSTRACT

A solid electrolyte contains a compound represented by a formula (1), and in a Raman spectrum, a peak portion width at an intensity that is half an intensity of a strongest peak P_{A} within a range of 200 to 450 cm⁻¹ is 55 cm⁻¹ or more, and a peak portion width at an intensity that is half an intensity of a strongest peak P_{B} within a range of 80 to 200 cm⁻¹ is 55 cm⁻¹ or more. LiₐA_{b}E_{c}JₑX_{f}Hₕ (1) (A is at least one element selected from alkali metals other than Li and alkaline earth metals, E is at least one element selected from the group including Al, Ga, In, Sc, Y, Ti, Zr, Hf, and lanthanoids, J is at least one group selected from the group including anions, and X is at least one element selected from the group including F, Cl, Br, and I.)

### TECHNICAL FIELD

The present invention relates to a solid electrolyte, a solid electrolyte layer, and a solid electrolyte battery.

The present application claims priority on Japanese Patent Application No. 2022-157983 filed on Sep. 30, 2022, the content of which is incorporated herein by reference.

### BACKGROUND ART

In recent years, development of electronic technology has been remarkable, and the size and weight reduction, thickness reduction, and multifuntionalization of mobile electronic devices have been achieved. Accordingly, there has been a strong desire for the size and weight reduction, thickness reduction, and reliability improvement of batteries that serve as power supplies of electronic devices, and solid electrolyte batteries for which a solid electrolyte is used as an electrolyte have been drawing attention. As solid electrolytes, oxide-based solid electrolytes, sulfide-based solid electrolytes, complex hydride-based solid electrolytes, halide-based solid electrolytes, and the like are known.

For example, Non Patent Document 1 describes that Li₃ScCl₆ that is a halide-based solid electrolyte has an ion conductivity of 3 mS/cm and the potential window on the reduction side is 0.91 V (V vs. Li/Li⁺).

### CITATION LIST

### Patent Document

Patent Document 1: Japanese Unexamined Patent Application, First Publication No. 2022-122849

### Non Patent Document

Non Patent Document 1: Jianwen Liang et al., J. Am. Chem. Soc., 2020, 142, pages 7012 to 7022.

Non Patent Document 2: R. J. H. Clark, “The impact of Laser-Raman spectroscopy on inorganic chemistry”, The SPEX Speaker Vol. XVIII, No. 1 (March, 1973)

### SUMMARY OF INVENTION

### Technical Problem

Halide-based solid electrolytes are said to have a higher ion conductivity than those of oxide-based solid electrolytes, sulfide-based solid electrolytes, complex hydride-based solid electrolytes, and the like. Li₃ScCl₆ described in Non Patent Document 1 has a high ion conductivity (3 mS/cm); however, due to a variety of limitations, there are cases where characteristics described in Non Patent Document 1 are not developed as they are or even cases where there is no choice but to select a different substance. Therefore, there is a demand for a material capable of relatively improving the ion conductivity in solid electrolytes having the same structure.

Li₂ZrCl₆ or Li₂Zr(SO₄)Cl₄ that is known as a halide-based solid electrolyte (for example, refer to Patent Document 1) is a solid electrolyte material that is advantageous in terms of resource availability and cost since Zr, the abundance ratio of which in the Earth's crust is high, is used as a central metal. However, the ion conductivity thereof is 4×10⁻⁴ S/cm, and the rate characteristics of the charging and discharging of batteries in which this solid electrolyte is used are insufficient.

The present invention has been made in consideration of the above-described problem, and an object of the present invention is to provide a solid electrolyte, a solid electrolyte layer, and a solid electrolyte battery that have a high ion conductivity.

### Solution to Problem

The present inventors repeated intensive studies, succeeded in improving the ion conductivity of a halide-based solid electrolyte without changing the composition, and completed the present invention.

The present invention provides the following solutions to solve the above-described problem.

A solid electrolyte according to Aspect 1 of the present invention contains a compound represented by the following formula (1) and has one peak portion in each of a range of 200 to 450 cm⁻¹ and a range of 80 to 200 cm⁻¹ in a Raman spectrum detected by Raman spectroscopy, and when the peak portion within the range of 200 to 450 cm⁻¹ is defined as a peak portion A, a straight line that connects a starting point 1A and a starting point 2A of the peak portion A is defined as a baseline A, the peak portion within the range of 80 to 200 cm⁻¹ is defined as a peak portion B, and a straight line that connects a starting point 1B and a starting point 2B of the peak portion B is defined as a baseline B, a peak portion width at an intensity that is half an intensity of a strongest peak P_{A} from the baseline A of the peak portion A is 55 cm⁻¹ or more, and a peak portion width at an intensity that is half an intensity of a strongest peak P_{B} from the baseline B of the peak portion B is 55 cm⁻¹ or more;

LiₐA_{b}E_{c}J_{c}X_{f}Hₕ (1)
(in the formula (1), A is at least one element selected from alkali metals other than Li and alkaline earth metals, E is at least one element selected from the group consisting of Al, Ga, In, Sc, Y, Ti, Zr, Hf, and lanthanoids, J is at least one group selected from the group consisting of anions, X is at least one element selected from the group consisting of F, Cl, Br, and I, 0.5≤a≤6, 0≤b≤6, 0<c<2, 0<e≤6, 0<f≤6.1, and 0≤h≤0.2.)

A solid electrolyte layer according to Aspect 2 of the present invention contains the solid electrolyte of Aspect 1.

A solid electrolyte battery according to Aspect 3 of the present invention includes a solid electrolyte layer, a positive electrode, and a negative electrode, and at least one of the positive electrode and the negative electrode contains the solid electrolyte of Aspect 1.

A solid electrolyte battery according to Aspect 4 of the present invention includes the solid electrolyte layer of Aspect 2, a positive electrode, and a negative electrode.

### Advantageous Effects of Invention

According to the aspects of the present invention, it is possible to provide a solid electrolyte having a high ion conductivity.

### BRIEF DESCRIPTION OF DRAWINGS

FIG. 1 A graph showing a Raman spectrum of Li₂ZrSO₄Cl₄ provided with a high ion conductivity that is one example of a solid electrolyte according to the present embodiment.

FIG. 2 A view for describing an evaluation method 1 of Raman spectral characteristics based on a graph obtained by enlarging a part surrounded by a dotted line indicated by P1 on the Raman spectrum shown in FIG. 1.

FIG. 3 A view for describing an evaluation method 2 of Raman spectral characteristics.

FIG. 4 A view for describing the evaluation method 2 of Raman spectral characteristics.

FIG. 5 A schematic cross-sectional view of a solid electrolyte battery according to the present embodiment.

FIG. 6A A view showing an evaluation of Raman spectral characteristics by the evaluation method 1 performed on the Raman spectrum of Example 4.

FIG. 6B A view showing an evaluation of the Raman spectral characteristics by the evaluation method 2 performed on the Raman spectrum of Example 4.

FIG. 7A A view showing an evaluation of Raman spectral characteristics by the evaluation method 1 performed on the Raman spectrum of Example 25.

FIG. 7B A view showing an evaluation of the Raman spectral characteristics by the evaluation method 2 performed on the Raman spectrum of Example 25.

FIG. 8 A view showing an evaluation of Raman spectral characteristics by the evaluation method 1 performed on a Raman spectrum of Comparative Example 1.

FIG. 9 A view showing an evaluation of Raman spectral characteristics by the evaluation method 1 performed on a Raman spectrum of Comparative Example 2.

### DESCRIPTION OF EMBODIMENTS

Hereinafter, the present embodiment will be described in detail with appropriate reference to drawings. In the drawings to be used in the following description, there are cases where a characteristic part is shown in an enlarged manner for convenience in order to make a characteristic of the present invention easily understood, and the dimensional ratio or the like of each configuration element is different from the actual one in some cases. Materials, dimensions, and the like to be exemplified in the following description are examples, the present invention is not limited thereto, and the present embodiment can be performed after being changed as appropriate to an extent that a technical feature thereof is not changed.

The expression “a±b” indicates a range from a value of “a−b” to a value of “a+b.” In addition, the expression “aE−b” indicates a value of “a×10^{-b}”.

### Solid Electrolyte

A solid electrolyte is a substance capable of causing migration of ions when an electric field is applied from outside. When the ion conductivity of the solid electrolyte is high, ions are smoothly exchanged in a solid electrolyte battery, and the internal resistance becomes small.

The solid electrolyte contains a halide-based solid electrolyte represented by LiₐA_{b}E_{c}JₑX_{f}Hₕ . . . (1). The solid electrolyte may contain a material originating from a raw material powder aside from the compound represented by the formula (1). The substance originating from the raw material powder is, for example, Li₂SO₄.

The solid electrolyte may be a powder (particle) form or may be a form of a sintered body obtained by sintering a powder. In addition, the solid electrolyte may be a molded body molded by compressing a powder, a molded body obtained by molding a mixture of a powder and a binder, or a coated film formed by applying a paint containing a powder, a binder, and a solvent and then heating the applied paint to remove the solvent. In addition, the main structure of the solid electrolyte may be amorphous or crystalline.

In the formula (1), Li is a lithium ion. a satisfies 0.5≤a<6, preferably satisfies 2.0≤a≤4.0, and more preferably satisfies 2.5≤a≤3.5. In a case where E is Zr or Hf, a is preferably 1.0≤a≤3.0 and more preferably 1.5≤a≤2.5. In the compound represented by the formula (1), when a is 0.5≤a<6, the amount of Li that is contained in the compound becomes appropriate, and the ion conductivity of a solid electrolyte 10 becomes high.

In the formula (1), A is at least one element selected from alkali metals other than Li and alkaline earth metals. A substitutes some of Li ions. A is, for example, Na or Ca. In a case where A is Na or Ca, the potential window on the reduction side of the solid electrolyte becomes wide. B satisfies 0≤b<6. In addition, a+b satisfies 0.5≤a+b<6.

In the formula (1), E is an essential component and is at least one element selected from the group consisting of Al, Ga, In, Sc, Y, Ti, Zr, Hf, and lanthanoids (La, Ce, Pr, Nd, Pm, Sm, Eu, Gd, Tb, Dy, Ho, Er, Tm, Yb, and Lu). As E, Al, Sc, Y, Zr, Hf, or La is preferably contained, and Zr or Y is more preferably contained. E improves the ion conductivity of the solid electrolyte. c is 0<c<2. c is preferably 0.6≤c since the effect of E being contained can be more effectively obtained. In addition, E is an element that forms the skeleton of the solid electrolyte. c is more preferably c≤1.

In the formula (1), J is at least one group selected from the group consisting of anions. J is, for example, at least one group selected from the group consisting of anions that are OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH═CH—COO, C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, CH₃COO, and O (BOB is bis(oxalate)borate, OOC—(CH₂)₂—COO is an anion of succinic acid, OOC—CH₂—COO is an anion of malonic acid, OOC—CH(OH)—CH(OH)—COO is an anion of tartaric acid, OOC—CH(OH)—CH₂—COO is an anion of malic acid, C₆H₅SO₃ is an anion of benzenesulfonic acid, OOC—CH═CH—COO (trans type) is an anion of fumaric acid, OOC—CH═CH—COO (cis type) is an anion of maleic acid, and C(OH)(CH₂COOH)₂COO is an anion of citric acid).

When the above-described anion is selected as the group, a high ion conductivity can be obtained, and reduction resistance improves.

e satisfies 0≤e≤6. 0.5≤e is preferable since e makes the effect of J being contained that widens the potential window on the reduction side more significant. e is preferably e≤3 so that a decrease in the ion conductivity of the solid electrolyte resulting from an excessively large amount of J is not caused.

X is at least one or more selected from the group consisting of F, Cl, Br, and I. In order to increase the ion conductivity of the solid electrolyte, X is preferably at least one or more selected from the group consisting of Cl, Br, and I, either one or both of Br and I are preferably contained, and I is particularly preferably contained. In a case where F is contained as X, F and two or more selected from the group consisting of Cl, Br, and I are preferably contained as X since the ion conductivity of the solid electrolyte becomes high.

In a case where X is F, the solid electrolyte has a sufficiently high ion conductivity and excellent oxidation resistance. In a case where X is Cl, the solid electrolyte has a high ion conductivity and a favorable balance between oxidation resistance and reduction resistance. In a case where X is Br, the solid electrolyte has a sufficiently high ion conductivity and a favorable balance between oxidation resistance and reduction resistance. In a case where X is I, the solid electrolyte has a high ion conductivity.

f satisfies 0<f≤6.1. f preferably satisfies 1≤f. When f satisfies 1≤f, in a case where the solid electrolyte is pressed and molded in a pellet shape, the strength of the pellet becomes high. In addition, when f satisfies 1≤f, the ion conductivity of the solid electrolyte becomes high. In addition, f is preferably f≤5 to prevent the amount of X from becoming too large, which makes the amount of sulfate insufficient and narrows the potential window of the solid electrolyte.

In the formula (1), H is hydrogen. h satisfies 0≤h≤0.2.

The solid electrolyte is, for example, Li₂ZrSO₄Cl₄, Li₃YSO₄Cl₄, Li₃ScSO₄Cl₄, or Li₃InSO₄Cl₄.

### (Raman Spectral Characteristics (Evaluation Method 1))

The solid electrolyte according to the present embodiment has one peak portion in each of a range of 200 to 450 cm⁻¹ and a range of 80 to 200 cm⁻¹ in a Raman spectrum detected by Raman spectroscopy, when the peak portion within the range of 200 to 450 cm⁻¹ is defined as a peak portion A, a straight line that connects a starting point 1A and a starting point 2A of the peak portion A is defined as a baseline A, the peak portion within the range of 80 to 200 cm⁻¹ is defined as a peak portion B, and a straight line that connects a starting point 1B and a starting point 2B of the peak portion B is defined as a baseline B, a peak portion width at an intensity that is half the intensity of a strongest peak from the baseline A of the peak portion A is 55 cm⁻¹ or more, and a peak portion width at an intensity that is half the intensity of a strongest peak from the baseline B of the peak portion B is 55 cm⁻¹ or more. Raman spectral characteristics by an evaluation method 1 will be described below in detail.

In the Raman spectroscopy, light is made incident on a substance, and an evaluation of the substance is performed from Raman scattered light having a wavelength different from that of the incident light, and the wavelength difference between the Raman scattered light and the incident light corresponds to the amount of vibration energy that the substance has, and it is thus possible to investigate a variety of physical properties of the substance from the Raman spectrum. As a result of intensive studies, the present inventors found that the ion conductivity can be improved with no changes in composition and the improvement in ion conductivity and the characteristics of the Raman spectrum correlate with each other.

In the case of a highly crystalline solid having regular crystal lattices, a peak corresponding to each vibration energy becomes sharp, but a wide peak reflects a disorder of crystallinity (promotion of an amorphous structure). The present inventors found that the ion conductivity becomes high by synthesizing the solid electrolyte such that the crystallinity becomes low (an amorphous structure is promoted) even in the same composition and a peak becomes wider in the Raman spectrum thereof, which reflects the promotion of the amorphous structure, and obtained an idea of the present invention.

“Peak portion” is an overlap of a plurality of peaks, and the solid electrolyte, which is a subject of the present embodiment, has one bundle of the overlaps of a plurality of peaks in each of the range of 200 to 450 cm⁻¹ and the range of 80 to 200 cm⁻¹. “Peak portion” reflects an overlap of peaks and varies in intensity, but “peak portion” touches neither the baseline A nor the baseline B at points other than two contact points with the spectrum, which are starting points of the base lines, (when not touching, the peak portion is evaluated as the same “peak portion”).

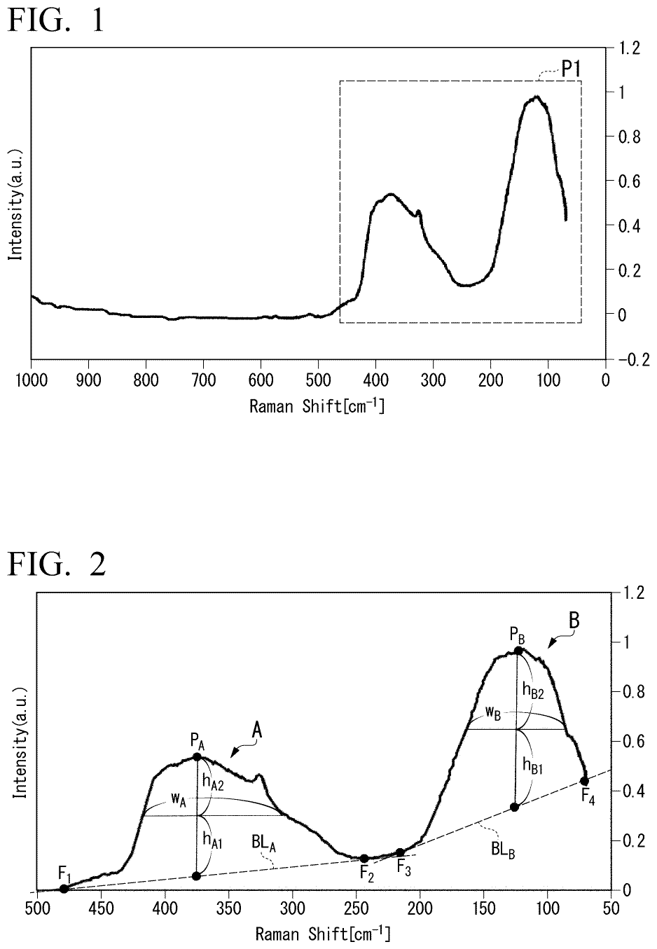

FIG. 1 is a graph showing the Raman spectrum of Li₂ZrSO₄Cl₄ provided with a high ion conductivity, which is one example of a solid electrolyte according to the present embodiment (20 to 1000 cm⁻¹). FIG. 2 is a graph obtained by enlarging a part surrounded by a dotted line indicated by P1 on the Raman spectrum shown in FIG. 1 (50 to 500 cm⁻¹).

The evaluation method 1 of the Raman spectral characteristics of the solid electrolyte according to the present embodiment will be described using FIG. 1 and FIG. 2.

In FIG. 1, the spectrum of the part surrounded by the dotted line indicated by P1 is a spectrum derived from the vibration energy of a metal (M)-halogen (X) bond. In a Raman spectrum detected by the Raman spectroscopy, as M or X becomes heavier, the peak shifts more toward the low wave number side.

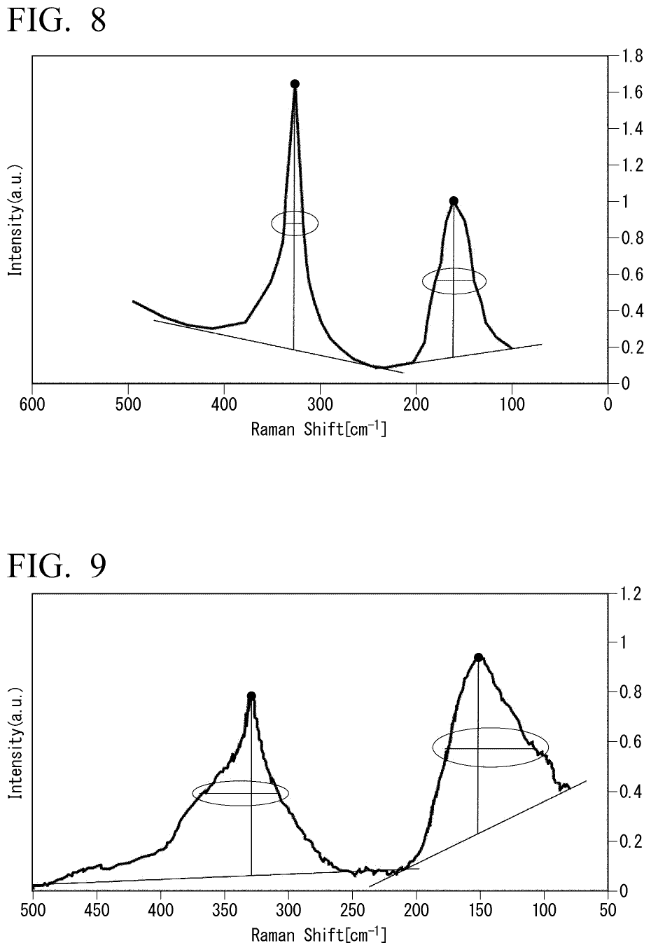

In FIG. 8 of Non Patent Document 2, it is shown that peaks shift toward the low wave number side as X is changed to Cl, Br, and I. The number of peaks depends on a compound, but those peaks overlap to form two peak portions, one peak portion is present within a range of 200 to 450 cm¹, and the other peak portion is present within a range of 80 to 200 cm⁻¹.

In an example of a Li—Sc—Cl-based compound of Non Patent Document 1, although Sc is lighter than Zr, but the peak in a range of 200 to 450 cm⁻¹ is present on the low wave number side compared with that in the example of the Li—Zr—Cl-based compound, but the peak in a range of 200 cm⁻¹ or lower is present on the high wave number side, and the peak is included in the range of the present embodiment.

Even when M or X of a Li-M (metal)-X (halogen)-based compound is changed, the peak derived from the M-X bond is considered to be included in the range of the present embodiment.

In the Raman spectrum (50 to 500 cm⁻¹) of FIG. 2, there are two peak portions, that is, a peak portion indicated by a reference sign A (hereinafter, referred to as “peak portion A” in some cases) and a peak portion indicated by a reference sign B (hereinafter, referred to as “peak portion B” in some cases).

In the present specification, “peak portions” (in FIG. 2, the portion indicated by the reference sign A is the peak portion A, and the portion indicated by the reference sign B is the peak portion B) are determined as described below.

A straight line that is parallel to the horizontal axis and is longer than the wave number range of 50 to 500 cm⁻¹ is moved toward high relative intensities while remaining parallel to the horizontal axis, and a point where the straight line hits the Raman spectrum for the first time is referred to as “starting point 1A” (indicated by a reference sign F1 in FIG. 2). The starting point 1A is a point where the relative intensity is the lowest within the wave number range of 50 to 500 cm⁻¹. The straight line is tilted from this starting point 1A as a basis (fixation point).

When the starting point 1A is present at a position where the wave number is 350 cm⁻¹ or more in the Raman spectrum, a point where the straight line is rotated to the left while fixing the starting point 1A as a basis (fixation point) and then hits the Raman spectrum is referred to as “starting point 2A” (indicated by a reference sign F2 in FIG. 2). A straight line that connects the starting point 1A and the starting point 2A is referred to as a baseline A (indicated by a reference sign BLA in FIG. 2), and a part between the baseline A and the Raman spectrum is the peak portion A. At the time of determining the starting point 2A, when the straight line hits the Raman spectrum at a position where the wave number is smaller than the wave number of the starting point 1A by approximately 30 cm⁻¹ or less, that point is not determined as the starting point 2A, and the starting point 2A is determined at a position beyond the point where the rise in intensity reaches the top.

In the Raman spectrum, in a case where the starting point 1A is present at a position where the wave number is less than 350 cm⁻¹, a point where the straight line is rotated to the right while fixing the starting point IA as a basis and then hits the Raman spectrum is referred to as the starting point 2A.

Next, a straight line that is parallel to the horizontal axis and is longer than the wave number range of 50 to 500 cm⁻¹ is moved from high relative intensities toward low relative intensities while remaining parallel to the horizontal axis, on the low wave number side of the peak portion A, the straight line is further moved toward low relative intensities from the point where the straight line hits the Raman spectrum for the first time, and a point immediately before the straight line deviates from the Raman spectrum for the first time is defined as “starting point 1B” (indicated by a reference sign F4 in FIG. 2). In the Raman spectrum, in a case where the starting point 1B is present at a position where the wave number is less than 150 cm⁻¹, the straight line is rotated to the left while fixing this starting point 1B as a basis (fixation point), and a point immediately before the straight line deviates from the Raman spectrum is defined as “starting point 2B” (indicated by a reference sign F3 in FIG. 2). A straight line that connects the starting point 1B and the starting point 2B is referred to as a baseline B (indicated by a reference sign BLB in FIG. 2), and a part between the baseline B and the Raman spectrum is the peak portion B. At the time of determining the starting point 2B, when the straight line deviates from the Raman spectrum at a position where the wave number is smaller than the wave number of the starting point 1B by approximately 30 cm⁻¹ or less, that point is not determined as the starting point 2B, and the starting point 2B is determined at a position beyond the point where the rise in intensity reaches the top.

In the Raman spectrum, when the starting point 1B is present at a position where the wave number is 150 cm⁻¹ or more, a point immediately before the straight line is rotated to the right while fixing the starting point 1B as a basis and then deviates from the Raman spectrum is referred to as the starting point 2B.

The peak portion A and the peak portion B determined as described above are present in a range of 200 to 450 cm⁻¹ and in a range of 80 to 200 cm⁻¹, respectively in the Raman spectrum of the solid electrolyte according to the present embodiment.

Hitherto, a method for determining the peak portion A and the peak portion B based on the Raman spectrum of FIG. 2 has been described, and the peak portion A and the peak portion B can be determined by the same method even in other Raman spectra.

In each of the peak portion A and the peak portion B, a peak at a wave number where the relative intensity is maximized is referred to as “strongest peak.” In FIG. 2, the tops of the peaks indicated by the reference sign P_{A} and the reference sign P_{B} are the strongest peak of the peak portion A and the strongest peak of the peak portion B, respectively.

In the solid electrolyte according to the present embodiment, a peak portion width W_{A} at an intensity h_{A1} that is half the intensity (h_{A1}+h_{A2}) of the strongest peak P_{A} from the baseline A of the peak portion A is 55 cm⁻¹ or more, and a peak portion width W_{B} at an intensity h_{B1} that is half the intensity (h_{B1}+h_{B2}) of the strongest peak P_{B} from the baseline B of the peak portion B is 55 cm⁻¹ or more.

In Li₂ZrSO₄Cl₄ provided with a high ion conductivity shown in FIG. 2, the peak portion width W_{A} is 121.7 cm⁻¹, and the peak portion width W_{B} is 85.7 cm⁻¹. In Li₂ZrSO₄Cl₄ not provided with a high ion conductivity, the peak portion width W_{A} is 53.6 cm⁻¹, and the peak portion width W_{B} is 64.9 cm⁻¹.

In the solid electrolyte according to the present embodiment, it is preferable that the peak portion width W_{A} is 55 cm⁻¹ or more, and the peak portion width W_{B} is 66 cm¹ or more, and the peak portion width W_{B} is more preferably 80 cm⁻¹ or more.

In the solid electrolyte according to the present embodiment, the wave number of the strongest peak P_{B} in the peak portion B is preferably 140 cm⁻¹ or less. The Raman spectrum within a range of 80 to 200 cm⁻¹ is a peak resulting from the bending of the metal-halogen bond, and when this peak position shifts toward the low wave number side while the peak maintains a wide half width, it is possible to have a metal-halogen bond with a wide energy distribution, it becomes easy for a conduction path of a Li⁺ ion to be formed, and a high ion conductivity is shown.

### (Raman Spectral Characteristics (Evaluation Method 2))

For the solid electrolyte according to the present embodiment, in the Raman spectrum detected by the Raman spectroscopy, a straight line that passes through a point X of the minimum value and a point Y of the local minimum value that is second smallest in a region of 400 to 1000 cm⁻¹ is defined as a baseline C, the intensities of the strongest peak P_{A} in the peak portion A and the strongest peak P_{B} in the peak portion B from the baseline C are defined as 1A and 1B, respectively, and an intensity at which the intensity from the baseline C is minimized between the peak portion A and the peak portion B is defined as IC, 0<IC is satisfied.

Due to a disorder of the crystal structure, the distribution of the metal-halogen binding energy spreads, spread toward the lower limit side of the vibration mode at the lower limit of the region of the peak portion A and spread toward the upper limit side of the vibration mode at the upper limit of the region of the peak portion B occur, and discrimination of the regions of the two peak portions becomes unclear, whereby the migration probability of a Li⁺ ion increases, and a high ion conductivity is shown.

Raman spectral characteristics by an evaluation method 2 will be described below in detail.

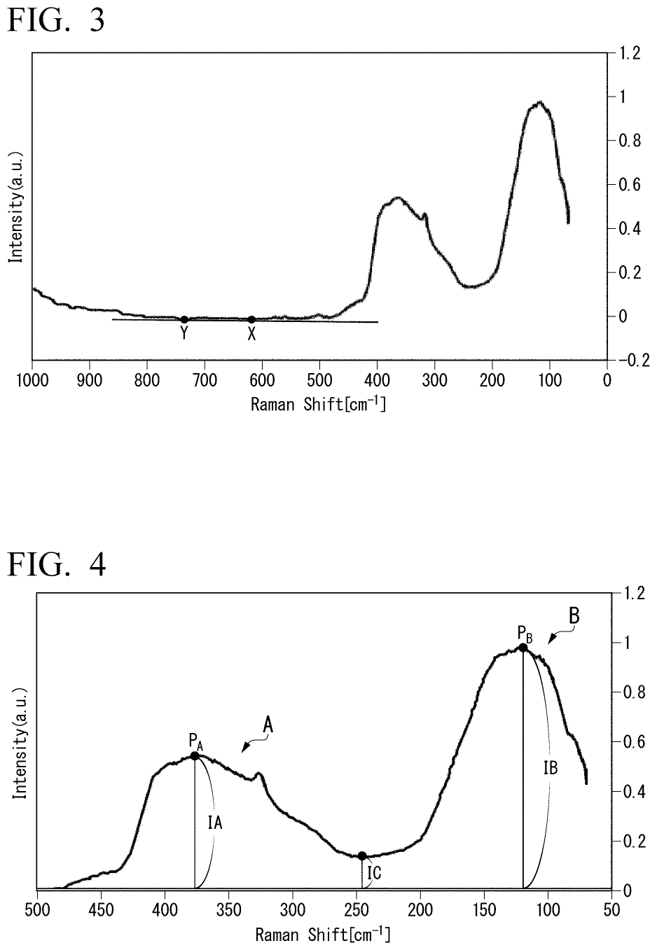

The evaluation method 2 of the Ramin spectral characteristics of the solid electrolyte according to the present embodiment will be described using FIG. 3 and FIG. 4.

First, as shown in FIG. 3, a line that passes through the point X of the minimum value of the relative intensities and the point Y of the local minimum value that is second smallest in relative intensity within a range of 400 to 1000 cm⁻¹ is defined as the baseline C.

Next, when the intensities of the strongest peak P_{A} in the peak portion A and the strongest peak P_{B} in the peak portion B from the baseline C are defined as IA and IB, respectively, and the intensity at which the intensity from the baseline C is minimized between the peak portion A and the peak portion B is defined as IC as shown in FIG. 4, 0<IC is satisfied.

In the solid electrolyte according to the present embodiment, the intensity IA of the strongest peak P_{A} in the peak portion A and the minimum intensity IC preferably satisfy 0.2≤IC/IA≤0.6.

In addition, in the solid electrolyte according to the present embodiment, the intensity TB of the strongest peak P_{B} in the peak portion B and the minimum intensity IC preferably satisfy 0.1≤IC/IB≤0.6.

In addition, in the solid electrolyte according to the present embodiment, the intensity IA of the strongest peak P_{A} in the peak portion A and the intensity IB of the strongest peak P_{B} in the peak portion B preferably satisfy IA<IB.

The solid electrolyte according to the present embodiment preferably has peaks in a range of 170±0.5 eV (the chemical state of sulfur corresponds to SO₄) and a range of 532±0.5 eV (the chemical state of oxygen corresponds to SO₄) in a photoelectron spectrum measured by X-ray photoelectron spectroscopy (XPS).

Sulfur and oxygen in the solid electrolyte strongly bond to each other and are present in a solid electrolyte material while maintaining the SO₄ structure, an amorphous structure is promoted, it becomes easy for a conduction path of a Li⁺ ion to be formed, and a high ion conductivity is shown.

The solid electrolyte according to the present embodiment preferably has peaks in a range of 132±0.5 eV (the chemical state of phosphorus corresponds to PO₄) and in a range of 531.5±0.5 eV (the chemical state of oxygen corresponds to PO₄) in the photoelectron spectrum measured by X-ray photoelectron spectroscopy (XPS).

Phosphorus and oxygen in the solid electrolyte tightly bond to each other and are present in a solid electrolyte material while maintaining the PO₄ structure, an amorphous structure is promoted, it becomes easy for a conduction path of a Li⁺ ion to be formed, and a high ion conductivity is shown.

### “Solid Electrolyte Battery”

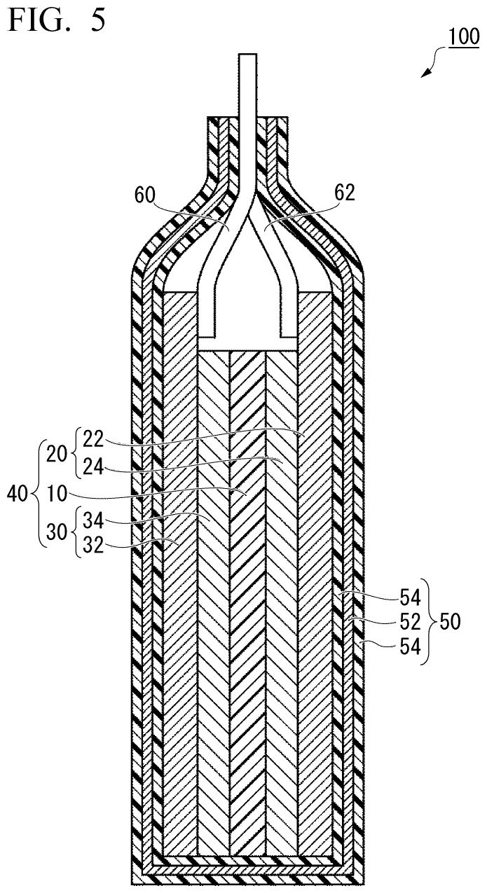

FIG. 5 is a schematic cross-sectional view of a solid electrolyte battery 100 according to the present embodiment. The solid electrolyte battery 100 shown in FIG. 5 includes a power generation element 40 and an exterior body 50. The exterior body 50 covers the circumference of the power generation element 40. The power generation element 40 is connected to outside through a pair of terminals 60 and 62 connected to each other. In FIG. 1, a stacked battery has been shown, but the battery may be a wound battery. The solid electrolyte battery 100 is used in, for example, laminated batteries, square batteries, cylindrical batteries, coin batteries, button batteries, and the like.

### <Power Generation Element>

The power generation element 40 includes a solid electrolyte layer 10, a positive electrode 20, and a negative electrode 30. The power generation element 40 exchanges ions between the positive electrode 20 and the negative electrode 30 through the solid electrolyte layer 10 and exchanges electrons through an external circuit; and thereby, charging and discharging are performed.

### (Solid Electrolyte Layer)

The solid electrolyte layer 10 is a layer containing the solid electrolyte according to the present embodiment. The solid electrolyte layer 10 may be only the solid electrolyte according to the present embodiment, but may also be used with a binder or a support such as a nonwoven fabric. As the binder, the same binder as that is used in the electrodes can be used.

The rate of the binder relative to the solid electrolyte is preferably 10% or less in terms of volume ratio. The support such as a nonwoven fabric needs to be insulating like a resin that is used as the binder, ceramic, glass or the like, and the opening rate is preferably 85% or more.

The solid electrolyte layer 10 is interposed between the positive electrode 20 and the negative electrode 30. The solid electrolyte layer 10 contains a solid electrolyte capable of causing migration of ions with a voltage applied from outside. For example, the solid electrolyte conducts lithium ions and hinders the migration of electrons.

The solid electrolyte layer 10 is, for example, a halide-based solid electrolyte. The solid electrolyte layer 10 contains, for example, the above-described solid electrolyte. In a case where the above-described solid electrolyte is contained in the positive electrode 20 or the negative electrode 30, the solid electrolyte that is contained in the solid electrolyte layer 10 may not be the above-described substance.

### (Positive Electrode)

As shown in FIG. 5, the positive electrode 20 includes a plate-like (foil-like) positive electrode current collector 22 and a positive electrode mixture layer 24. The positive electrode mixture layer 24 is in contact with at least one surface of the positive electrode current collector 22.

The positive electrode current collector 22 needs to be an electron-conductive material that withstands oxidation during charging and does not easily corrode. The positive electrode current collector 22 is, for example, a metal such as aluminum, stainless steel, nickel, or titanium, a conductive resin, or the like. The positive electrode current collector 22 may be each of a powder form, a foil form, a punched form, or an expanded form.

The positive electrode mixture layer 24 contains a positive electrode active material and contains a solid electrolyte, a binder, and a conductive assistant as necessary.

The positive electrode active material is not particularly limited as long as the positive electrode active material is capable of making the insertion, release, intercalation, and deintercalation of lithium ions reversibly progress, and positive electrode active materials that are in use in well-known solid electrolyte batteries can be used. Examples of the positive electrode active material include lithium-containing metal oxides, lithium-containing metal phosphorus oxides, and the like.

Examples of the lithium-containing metal oxides include lithium cobalt oxide (LiCoO₂), lithium nickel oxide (LiNiO₂), lithium manganese spinel (LiMn₂O₄), composite metal oxides represented by a general formula: LiNiₓCo_{y}Mn_{z}O₂ (x+y+z=1), lithium vanadium compounds (LiVOPO₄ and Li₃V₂(PO₄)₃), olivine-type LiMPO₄ (M indicates at least one selected from Co, Ni, Mn, and Fe), lithium titanate (Li₄Ti₅O₁₂), and the like.

In addition, the positive electrode active material may not contain lithium. Examples of such a positive electrode active material include lithium-free metal oxides (MnO₂, V₂O₅, and the like), lithium-free metal sulfides (MoS₂ and the like), lithium-free fluorides (FeF₃, VF₃, and the like), and the like. In the case of using a positive electrode active material not containing lithium, lithium ions are doped into the negative electrode in advance or a negative electrode containing a lithium ion is used.

The solid electrolyte that is contained in the positive electrode 20 is, for example, the above-described solid electrolyte. The solid electrolyte that is contained in the positive electrode 20 may be a halide-based solid electrolyte other than the above-described solid electrolyte.

The amount rate of the solid electrolyte in the positive electrode mixture layer 24 is not particularly limited, but is preferably 1 mass % to 50 mass % and more preferably 5 mass % to 30 mass % based on the total mass of the positive electrode active material, the solid electrolyte, the conductive assistant, and the binder.

The binder binds the positive electrode active material, the solid electrolyte, and the conductive assistant to one another in the positive electrode mixture layer 24 and makes the positive electrode mixture layer 24 and the positive electrode current collector 22 strongly adhere to each other. The positive electrode mixture layer 24 preferably contains a binder. The binder is preferably oxidation-resistant and highly adhesive.

Examples of the binder that is used in the positive electrode mixture layer 24 include polyvinylidene fluoride (PVDF) and copolymers thereof, polytetrafluoroethylene (PTFE), polyamide (PA), polyimide (PI), polyamide-imide (PAI), polybenzimidazole (PBI), polyethersulfone (PES), polyacrylic acid (PA) and copolymers thereof, metal ion crosslinked bodies of polyacrylic acid (PA) and copolymers thereof, maleic anhydride-grafted polypropylene (PP), maleic anhydride-grafted polyethylene (PE), mixtures thereof, and the like. Among these, in particular, PVDF is preferably used as the binder.

The amount rate of the binder in the positive electrode mixture layer 24 is not particularly limited, but is preferably 1 mass % to 15 mass % and more preferably 3 mass % to 5 mass % based on the total mass of the positive electrode active material, the solid electrolyte, the conductive assistant, and the binder. In a case where the amount of the binder is too small, there is a tendency that it becomes impossible to form the positive electrode 20 having a sufficient adhesive strength. Conversely, in a case where the amount of the binder is too large, ordinary binders are electrochemically inactive and thus do not contribute to the discharge capacity, and there is a tendency that it becomes difficult to obtain a sufficient volume or mass energy density.

The conductive assistant improves the electron conductivity of the positive electrode mixture layer 24. As the conductive assistant, well-known conductive assistants can be used. The conductive assistant is, for example, a carbon material such as a carbon black, graphite, carbon nanotubes, or graphene, a metal such as aluminum, copper, nickel, stainless steel, iron, or an amorphous metal, a conductive oxide such as ITO, or a mixture thereof. The conductive assistant may be each of a powder form or a fiber form.

The amount rate of the conductive assistant in the positive electrode mixture layer 24 is not particularly limited. In the case of adding the conductive assistant, normally, the mass ratio of the conductive assistant is preferably 0.5 mass % to 20 mass % and more preferably 1 mass % to 5 mass % based on the total mass of the positive electrode active material, the solid electrolyte, the conductive assistant, and the binder.

### (Negative Electrode)

As shown in FIG. 5, the negative electrode 30 includes a negative electrode current collector 32 and a negative electrode mixture layer 34. The negative electrode mixture layer 34 is in contact with the negative electrode current collector 32.

The negative electrode current collector 32 needs to have electron conductivity. The negative electrode current collector 32 is, for example, a metal such as copper, aluminum, nickel, stainless steel, or iron, a conductive resin, or the like. The negative electrode current collector 32 may be each of a powder form, a foil form, a punched form, or an expanded form.

The negative electrode mixture layer 34 contains a negative electrode active material and contains a solid electrolyte, a binder, and a conductive assistant as necessary.

The negative electrode active material needs to be capable of making the insertion and release of lithium ions and the intercalation and deintercalation of lithium ions reversibly progress and is not particularly limited. As the negative electrode active material, negative electrode active materials that are in use in well-known solid electrolyte batteries can be used.

The negative electrode active material is, for example, a carbon material such as natural graphite, artificial graphite, mesocarbon microbeads, mesocarbon fibers (MCF), cokes, glassy carbon, or an organic compound sintered body, a metal that can be combined with lithium such as Si, SiOₓ, Sn, or aluminum, an alloy thereof, a composite material of these metal and carbon material, an oxide such as lithium titanate (Li₄Ti₅O₁₂) or SnO₂, metallic lithium, or the like. The negative electrode active material is preferably natural graphite.

The solid electrolyte that is contained in the negative electrode 30 is, for example, the above-described solid electrolyte. The solid electrolyte that is contained in the negative electrode 30 may be a halide-based solid electrolyte other than the above-described solid electrolyte.

The binder and the conductive assistant that are contained in the negative electrode 30 are the same as the binder and the conductive assistant that are contained in the positive electrode 20.

### <Exterior Body>

The exterior body 50 accommodates the power generation element 40 therein. The exterior body 50 prevents the intrusion of moisture or the like into the inside from the outside. The exterior body 50 includes a metal foil 52 and a resin layer 54 laminated on each surface of the metal foil 52 as shown in, for example, FIG. 5. The exterior body 50 is a metal-laminated film obtained by coating the metal foil 52 with the resin layers 54 from both sides.

The metal foil 52 is, for example, an aluminum foil or a stainless steel foil. As the resin layer 54, for example, a resin film of polypropylene or the like can be used. The materials that configure the inside and outside resin layers 54 may be different from each other. For example, a polymer having a high melting point, for example, polyethylene terephthalate (PET), polyamide (PA), or the like can be used as the material of the outside resin layer, and polyethylene (PE), polypropylene (PP), or the like can be used as the material of the inside resin layer.

### <Terminal>

The terminals 60 and 62 are connected to the positive electrode 20 and the negative electrode 30, respectively. The terminal 60 connected to the positive electrode 20 is a positive electrode terminal, and the terminal 62 connected to the negative electrode 30 is a negative electrode terminal. The terminals 60 and 62 are responsible for electric connection with the outside. The terminals 60 and 62 are formed of a conductive material such as aluminum, nickel, or copper. A connection method may be welding or fastening with a screw. The terminals 60 and 62 are preferably protected with insulation tape to prevent short circuit.

### [Method for Manufacturing Solid Electrolyte Battery]

Next, a method for manufacturing the solid electrolyte battery according to the present embodiment will be described. First, a solid electrolyte is prepared. The solid electrolyte can be manufactured by, for example, a method in which a raw material powder containing predetermined elements in a predetermined mole ratio is mixed and a mechanochemical reaction is caused. At the time of causing the mechanochemical reaction, an adjustment is made to leave an unreacted raw material in the solid electrolyte. Specifically, an unreacted component of the raw material can be left by changing the rotation speed or revolution speed of a planetary ball mill, the synthesis time, or the state of the raw material powder when it is charged.

Regarding the solid electrolyte according to the present embodiment, the solid electrolyte is synthesized so that the crystallinity becomes low (an amorphous structure is promoted) to improve the ion conductivity in spite of the same composition. In this synthesis method, the synthesis of the raw material powder is made to progress such that the crystallinity becoming excessively high is suppressed while the synthesis thereof progresses. There is no limitation on an adjustment method as long as such synthesis is enabled, but it has been found that, in particular, cooling immediately after the beginning of the synthesis, shortening of the synthesis time (a synthesis time is shorter than conventional synthesis times for each solid electrolyte while the conventional synthesis times vary with solid electrolytes), and adjustment of the dew point at the time of charging the raw material powder and at the time of work for sealing a container is important.

In a case where a halide raw material is contained in the raw material powder, the halide raw material is likely to evaporate when the temperature is raised. Therefore, a halogen may be supplemented by making a halogen gas coexist in the atmosphere at the time of sintering. In addition, in a case where a halide raw material is contained in the raw material powder, the raw material powder may be sintered by a hot press method using a highly airtight mold. In this case, since the mold is highly airtight, the evaporation of the halide raw material due to sintering can be suppressed. Sintering in such a manner makes it possible to obtain a solid electrolyte in a state of a sintered body composed of a compound having a predetermined composition.

Next, the positive electrode 20 is prepared. The positive electrode 20 is manufactured by applying a paste containing a positive electrode active material onto the positive electrode current collector 22 and drying the paste to form the positive electrode mixture layer 24. The solid electrolyte may be added to the paste containing a positive electrode active material.

Next, the negative electrode 30 is prepared. The negative electrode 30 is manufactured by applying a paste containing a negative electrode active material onto the negative electrode current collector 32 and drying the paste to form the negative electrode mixture layer 34. The solid electrolyte may be added to the paste containing a negative electrode active material.

The power generation element 40 can be produced using, for example, a powder molding method. A guide having a hole portion is installed on the positive electrode 20, and the guide is filled with the solid electrolyte. After that, the surface of the solid electrolyte is levelled, and the negative electrode 30 is overlaid on the solid electrolyte. This makes the solid electrolyte sandwiched between the positive electrode 20 and the negative electrode 30. After that, a pressure is applied to the positive electrode 20 and the negative electrode 30; and thereby, the solid electrolyte is pressed and molded. The pressing makes it possible to obtain a laminated body in which the positive electrode 20, the solid electrolyte layer 10, and the negative electrode 30 have been laminated in this order.

Next, external terminals are each welded to the positive electrode current collector 22 of the positive electrode 20 and the negative electrode current collector 32 of the negative electrode 30 that form the laminated body by a well-known method; and thereby, the positive electrode current collector 22 and the negative electrode current collector 32 are electrically connected to the external terminals, respectively. After that, the laminated body connected to the external terminals is accommodated in the exterior body 50, and an opening portion of the exterior body 50 is sealed by heat sealing. The solid electrolyte battery 100 of the present embodiment can be obtained by the above-described steps.

Since the solid electrolyte battery 100 according to the present embodiment contains the above-described solid electrolyte, the conduction of Li ions is smooth, and the internal resistance is low.

Hitherto, the embodiment of the present invention has been described in detail with reference to the drawings, each configuration, a combination thereof, and the like in each embodiment are examples, and addition, omission, substitution, and other modifications of the configuration of the present embodiment are possible without departing from the technical features of the present invention.

### EXAMPLES

### Example 1

### (Production of Solid Electrolyte)

Zirconium chloride (ZrCl₄) and lithium sulfate (Li₂SO₄) were each weighed in a glove box having a dew point of approximately −75 °C. so that the mole ratio therebetween reached a proportion of 1:8 and were charged into a zirconia airtight container for a planetary ball mill into which zirconia balls had been put in advance. Next, the airtight container was closed with a lid, the lid was fastened to a container main body with a screw, and furthermore, a space between the lid and the container was sealed with polyimide tape. The polyimide tape has an effect of blocking moisture. Next, the zirconia airtight container was set in a planetary ball mill. The rotation speed was set to 300 rpm, the revolution speed was set to 300 rpm, the rotation direction of the rotation and the rotation direction of the revolution were set to be opposite to each other, and a mechanochemical reaction was caused for 2.5 hours; and thereby, a solid electrolyte (Li₄Zr_{0.25}(SO₄)₂Cl) was synthesized. Synthesis was performed while cooling was performed such that the amount of the temperature of the lid of the zirconia airtight container changed reached 10 °C. or less after one hour from the beginning of the synthesis.

The planetary ball mill is normally installed in a normal atmosphere (the atmosphere). When the zirconia airtight container for a planetary ball mill is fastened with a screw and further sealed with polyimide tape, and the zirconia airtight container is set in a planetary ball mill, since the zirconia airtight container is a structure that is strongly pressed and fixed, it is considered that, even in the normal atmosphere, moisture rarely infiltrates into the zirconia airtight container from the atmosphere.

### <Measurement of Raman Spectrum>

The Raman spectrum of the solid electrolyte of Example 1 was measured by Raman spectroscopy.

As the measurement conditions of the Raman spectroscopy, the laser wavelength was 532 nm, the slit width was 100×1000 μm, the aperture was 40 μm, the exposure time was 60 seconds, and the accumulation was twice.

A peak portion A within a range of 200 to 450 cm⁻¹ and a peak portion B within a range of 80 to 200 cm⁻¹ were determined by an evaluation method 1, and the strongest peak and the half width in each peak portion were measured.

In addition, a baseline C was determined by an evaluation method 2, intensities IA and IB of a strongest peak P_{A} in the peak portion A and a strongest peak P_{B} in the peak portion B from the baseline C and an intensity IC at which the intensity from the baseline C was minimized between the peak portion A and the peak portion B were measured.

### <XPS Measurement>

In addition, regarding the solid electrolyte of Example 1, a photoelectron spectrum was measured by X-ray photoelectron spectroscopy. Sampling was performed in a glove box having a dew point of approximately −70 °C in which an argon gas was circulating, and a sample was transported up to an XPS measuring instrument in a state of being not exposed to the air. The photoelectron spectrum was measured using Quantera 2 manufactured by ULVAC-PHI, Inc. As a result, in the produced solid electrolyte, peaks were confirmed in a range of 170±0.5 eV and in a range of 532±0.5 eV.

### <Measurement of Ion Conductivity>

Next, in the glove box having a dew point of approximately −70 °C in which an argon gas was circulating, a press die was filled with a powder of the obtained solid electrolyte, the powder was pressed at a load of approximately 30 kN, and a measurement cell of the ion conductivity was produced.

The press die consisted of a PEEK (polyether ether ketone) cylinder having a diameter of 10 mm, and an upper punch and a lower punch that were each made of an SKD 11 material and had a diameter of 9.99 mm.

After that, stainless steel discs and TEFLON (registered trademark) discs that each had screw holes at four sites, a diameter of 50 mm, and a thickness of 5 mm were prepared, and the press die was set as described below. The stainless steel disc, the TEFLON (registered trademark) disc, the die after pressing, the TEFLON (registered trademark) disc, and the stainless steel disc were loaded in order, and screws at the four sites were fastened at a torque of approximately 3 N-m. In addition, screws were inserted into screw holes provided on the side surfaces of the upper and lower punches and used as external connection terminals.

The external connection terminals were connected to a potentiostat equipped with a frequency response analyzer (VersaSTAT3 manufactured by Princeton Applied Research), and the ion conductivity was measured using an impedance measurement method. The ion conductivity was measured at 25 °C within a measurement frequency range of 1 MHz to 0.1 Hz with an amplitude of 10 mV. The ion conductivity of the solid electrolyte of Example 1 was 1.1×10⁻³ S/cm.

The composition and mole ratio of each raw material and the measurement results are summarized in Tables 1, 2, and 7 below.

In Tables 7 and 8, a peak portion width at an intensity that was half the intensity of the strongest peak P_{A} (P_{B}) from the baseline A (B) of the peak portion A (B) is expressed as “half width.”

### Examples 2 to 8

In Examples 2 to 8, solid electrolytes were synthesized in the same manner as in Example 1 except that the material and/or mole ratio of a raw material powder and the synthesis time were changed. In Examples 2 to 8 as well, the physical property values of the solid electrolytes were measured in the same manner as in Example 1. The composition and mole ratio of each raw material and the measurement results are summarized in Tables 1, 2, and 7 below.

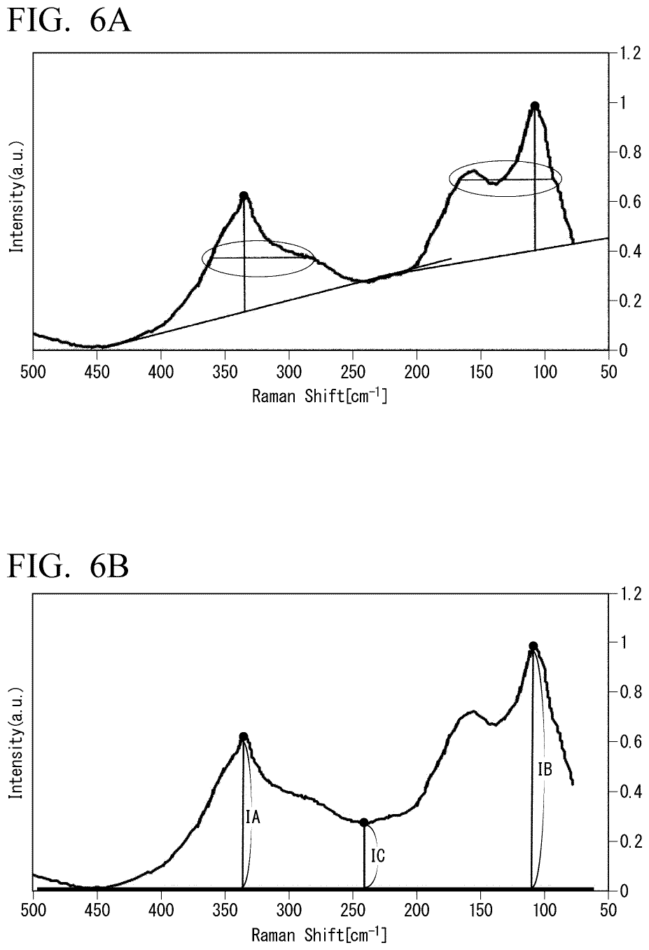

FIG. 6A shows a view in which an evaluation of Raman spectral characteristics was performed by the evaluation method 1 on the Raman spectrum of Example 4. FIG. 6B shows a view in which an evaluation of the Raman spectral characteristics was performed by the evaluation method 2 on the Raman spectrum of Example 4.

### Example 9

Zirconium sulfate (ZrSO₄), zirconium chloride (ZrCl₄), and lithium sulfate (Li₂SO₄) were each weighed in a glove box having a dew point of approximately −75 °C so that the mole ratio thereamong reached a proportion of 0.5:1:1 and were charged into a zirconia airtight container for a planetary ball mill into which zirconia balls had been put in advance. Next, the airtight container was closed with a lid, the lid was fastened to a container main body with a screw, and furthermore, a space between the lid and the container was sealed with polyimide tape. The polyimide tape has an effect of blocking moisture. Next, the zirconia airtight container was set in a planetary ball mill. The rotation speed was set to 300 rpm, the revolution speed was set to 300 rpm, the rotation direction of the rotation and the rotation direction of the revolution were set to be opposite to each other, and a mechanochemical reaction was caused for five hours; and thereby, a solid electrolyte (Li₂Zr_{1.5}(SO₄)₂Cl) was synthesized.

In detail, at the time of charging a raw material powder into the zirconia airtight container, Li₂SO₄ was pulverized using the same planetary ball mill device as described above at a rotation speed of 300 rpm for one hour before mixing. Next, ZrCl₄ was added thereto, and the components were further mixed and pulverized at a rotation speed of 200 rpm for one hour. Next, the remaining raw material (ZrSO₄ in Example 9) was added thereto; and thereby charging was completed.

Synthesis was performed while cooling was performed such that the amount of the temperature of the lid of the zirconia airtight container changed reached 10 °C or less after one hour from the beginning of the synthesis.

In Example 9 as well, the physical property values of the solid electrolyte were measured in the same manner as in Example 1. The composition and mole ratio of each raw material and the measurement results are summarized in Tables 1, 2, and 7 below.

### Example 10

In Example 10, a solid electrolyte was synthesized in the same manner as in Example 9 except that zirconium sulfate (ZrSO₄), zirconium chloride (ZrCl₄), and lithium sulfate (Li₂SO₄) were weighed so that the mole ratio thereamong reached a proportion of 0.4:1:1.5.

In Example 10 as well, the physical property values of the solid electrolyte were measured in the same manner as in Example 1. The composition and mole ratio of each raw material and the measurement results are summarized in Tables 1, 2, and 7 below.

### Examples 11 to 21

In Examples 11 to 21, solid electrolytes were synthesized in the same manner as in Example 9 except that the material and mole ratio of the raw material powder were changed. In Examples 11 to 21 as well, the physical property values of the solid electrolyte were measured in the same manner as in Example 9. The measurement results are summarized in Tables 1, 2, 7, and 8 below.

### Example 22

Lithium oxide (Li₂O) and zirconium chloride (ZrCl₄) were each weighed in a glove box having a dew point of approximately −75 °C so that the mole ratio therebetween reached a proportion of 10:1 and were charged into a zirconia airtight container for a planetary ball mill into which zirconia balls had been put in advance. Next, the airtight container was closed with a lid, the lid was fastened to a container main body with a screw, and furthermore, a space between the lid and the container was sealed with polyimide tape. The polyimide tape has an effect of blocking moisture.

Next, the zirconia airtight container was set in a planetary ball mill. The rotation speed was set to 300 rpm, the revolution speed was set to 300 rpm, the rotation direction of the rotation and the rotation direction of the revolution were set to be opposite to each other, and a mechanochemical reaction was caused for four hours; and thereby, a solid electrolyte (Li₁₀ZrO₅Cl₄) was synthesized.

In detail, at the time of charging a raw material powder into the zirconia airtight container, Li₂O was pulverized using the same planetary ball mill device as described above at a rotation speed of 300 rpm for one hour before mixing. Next, the remaining raw material (ZrCl₄ in Example 22) was added thereto.

Synthesis was performed while cooling was performed such that the amount of the temperature of the lid of the zirconia airtight container changed reached 10 °C or less after one hour from the beginning of the synthesis.

In Example 22 as well, the physical property values of the solid electrolyte were measured in the same manner as in Example 1. The composition and mole ratio of each raw material and the measurement results are summarized in Tables 3, 4, and 8 below.

### Examples 23 to 26

In Example 23, a solid electrolyte was synthesized in the same manner as in Example 22 except that the mole ratio of the raw material powder was changed and the synthesis time was set to six hours.

In Example 24, a solid electrolyte was synthesized in the same manner as in Example 22 except that the mole ratio of the raw material powder was changed and the synthesis time was set to 24 hours.

In Example 25, a solid electrolyte was synthesized in the same manner as in Example 22 except that the mole ratio of the raw material powder was changed and the synthesis time was set to 48 hours.

In Example 26, a solid electrolyte was synthesized in the same manner as in Example 22 except that the mole ratio of the raw material powder was changed and the synthesis time was set to 72 hours.

In Examples 23 to 26 as well, the physical property values of the solid electrolyte were measured in the same manner as in Example 22. The composition and mole ratio of each raw material and the measurement results are summarized in Tables 3, 4, and 8 below.

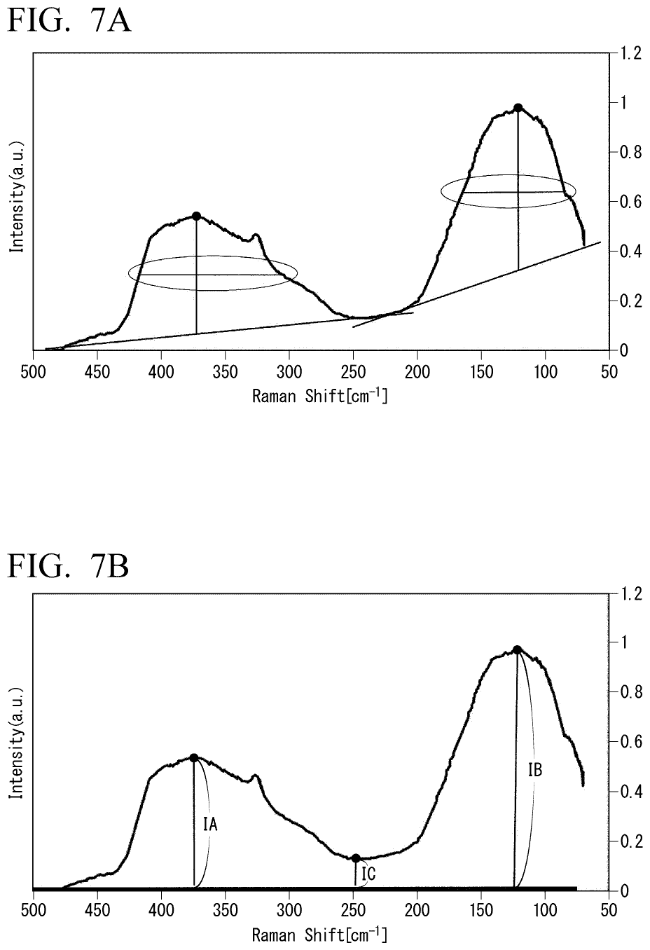

FIG. 7A shows a view in which an evaluation of Raman spectral characteristics was performed by the evaluation method 1 on the Raman spectrum of Example 25. FIG. 7B shows a view in which an evaluation of the Raman spectral characteristics was performed by the evaluation method 2 on the Raman spectrum of Example 25.

### Examples 27 to 30

In Examples 27 to 30, solid electrolytes were synthesized in the same manner as in Example 22 except that the material and mole ratio of the raw material powder were changed. In Examples 27 to 30 as well, the physical property values of the solid electrolyte were measured in the same manner as in Example 22. The composition and mole ratio of each raw material and the measurement results are summarized in Tables 3, 4, and 8 below.

### Example 31

In Example 31, a solid electrolyte was synthesized in the same manner as in Example 1 except that the charging of a raw material powder and work for sealing the container were performed in a dry room having a dew point of −40 °C. In Example 31 as well, the physical property values of the solid electrolyte were measured in the same manner as in Example 1. The composition and mole ratio of each raw material and the measurement results are summarized in Tables 3, 4, and 8 below.

### Example 32

In Example 32, a solid electrolyte was synthesized in the same manner as in Example 1 except that the charging of a raw material powder and work for sealing the container were performed in a dry room having a dew point of −60 °C. In Example 32 as well, the physical property values of the solid electrolyte were measured in the same manner as in Example 1. The composition and mole ratio of each raw material and the measurement results are summarized in Tables 3, 4, and 8 below.

### Example 33

In Example 33, a solid electrolyte was synthesized in the same manner as in Example 1 except that the mole ratio of the raw material powder was changed. In Example 33 as well, the physical property values of the solid electrolyte were measured in the same manner as in Example 1. The composition and mole ratio of each raw material and the measurement results are summarized in Tables 3, 4, and 8 below.

### Comparative Example 1

In Comparative Example 1, a solid electrolyte was synthesized in the same manner as in Example 1 except that the material and mole ratio of a raw material powder were changed and the cooling of the zirconia container for one hour from the beginning of the synthesis was not performed and the synthesis time was 24 hours. The amount of the temperature of the lid of the zirconia airtight container changed reached 20 °C or more after one hour from the beginning of the synthesis. In Comparative Example 1 as well, the physical property values of the solid electrolyte were measured in the same manner as in Example 1. The composition and mole ratio of each raw material and the measurement results are summarized in Tables 5, 6, and 9 below.

FIG. 8 shows a view in which an evaluation of Raman spectral characteristics was performed by the evaluation method 1 on the Raman spectrum of Comparative Example 1.

### Comparative Example 2

In Comparative Example 2, a solid electrolyte was synthesized in the same manner as in Example 1 except that the mole ratio of a raw material powder was changed, the cooling of the zirconia container for one hour from the beginning of the synthesis was not performed, and the synthesis time was 24 hours. The amount of the temperature of the lid of the zirconia airtight container changed reached 20 °C or more after one hour from the beginning of the synthesis. In Comparative Example 2 as well, the physical property values of the solid electrolyte were measured in the same manner as in Example 1. The composition and mole ratio of each raw material and the measurement results are summarized in Tables 5, 6, and 9 below.

FIG. 9 shows a view in which an evaluation of Raman spectral characteristics was performed by the evaluation method 1 on the Raman spectrum of Comparative Example 2.

### Comparative Example 3

In Comparative Example 3, a solid electrolyte was synthesized in the same manner as in Example 1 except that the charging of a raw material powder and work for sealing the container were performed in a dry room having a dew point of −20 °C and the synthesis time was 5.5 hours. In Comparative Example 3 as well, the physical property values of the solid electrolyte were measured in the same manner as in Example 1. The composition and mole ratio of each raw material and the measurement results are summarized in Tables 5, 6, and 9 below.

### Comparative Example 4

In Comparative Example 4, a solid electrolyte was synthesized in the same manner as in Example 4 except that the cooling of the zirconia container for one hour from the beginning of the synthesis was not performed. In Comparative Example 4 as well, the physical property values of the solid electrolyte were measured in the same manner as in Example 1. The composition and mole ratio of each raw material and the measurement results are summarized in Tables 5, 6, and 9 below.

### Comparative Example 5

In Comparative Example 5, a solid electrolyte was synthesized in the same manner as in Example 4 except that the synthesis time was 24 hours. In Comparative Example 5 as well, the physical property values of the solid electrolyte were measured in the same manner as in Example 1. The composition and mole ratio of each raw material and the measurement results are summarized in Tables 5, 6, and 9 below.

### Comparative Example 6

In Comparative Example 6, a solid electrolyte was synthesized in the same manner as in Example 17 except that the cooling of the zirconia container for one hour from the beginning of the synthesis was not performed. In Comparative Example 6 as well, the physical property values of the solid electrolyte were measured in the same manner as in Example 1. The composition and mole ratio of each raw material and the measurement results are summarized in Tables 5, 6, and 9 below.

### Comparative Example 7

In Comparative Example 7, a solid electrolyte was synthesized in the same manner as in Example 18 except that the synthesis time was 24 hours. In Comparative Example 7 as well, the physical property values of the solid electrolyte were measured in the same manner as in Example 1. The composition and mole ratio of each raw material and the measurement results are summarized in Tables 5, 6, and 9 below.

### Comparative Example 8

In Comparative Example 8, a solid electrolyte was synthesized in the same manner as in Example 23 except that the synthesis time was 24 hours. In Comparative Example 8 as well, the physical property values of the solid electrolyte were measured in the same manner as in Example 1. The composition and mole ratio of each raw material and the measurement results are summarized in Tables 5, 6, and 9 below.

### Comparative Example 9

In Comparative Example 9, a solid electrolyte was synthesized in the same manner as in Example 24 except that the synthesis time was 48 hours. In Comparative Example 9 as well, the physical property values of the solid electrolyte were measured in the same manner as in Example 1. The composition and mole ratio of each raw material and the measurement results are summarized in Tables 5, 6, and 9 below.

### Comparative Example 10

In Comparative Example 10, a solid electrolyte was synthesized in the same manner as in Example 25 except that the cooling of the zirconia container for one hour from the beginning of the synthesis was not performed. In Comparative Example 10 as well, the physical property values of the solid electrolyte were measured in the same manner as in Example 1. The composition and mole ratio of each raw material and the measurement results are summarized in Tables 5, 6, and 9 below.

### Comparative Example 11

In Comparative Example 11, a solid electrolyte was synthesized in the same manner as in Example 26 except that the cooling of the zirconia container for one hour from the beginning of the synthesis was not performed. In Comparative Example 11 as well, the physical property values of the solid electrolyte were measured in the same manner as in Example 1. The composition and mole ratio of each raw material and the measurement results are summarized in Tables 5, 6, and 9 below.

### Comparative Example 12

In Comparative Example 12, a solid electrolyte was synthesized in the same manner as in Example 27 except that the synthesis time was 96 hours. In Comparative Example 12 as well, the physical property values of the solid electrolyte were measured in the same manner as in Example 1. The composition and mole ratio of each raw material and the measurement results are summarized in Tables 5, 6, and 9 below.

### Comparative Example 13

In Comparative Example 13, a solid electrolyte was synthesized in the same manner as in Example 33 except that the synthesis time was 72 hours. In Comparative Example 13 as well, the physical property values of the solid electrolyte were measured in the same manner as in Example 1. The composition and mole ratio of each raw material and the measurement results are summarized in Tables 5, 6, and 9 below.

TABLE 1

| | | LiₐA_{b}E_{c}J_{c}X_{f}Hₕ | | | | | | | | | | | |
|---|---|---|---|---|---|---|---|---|---|---|---|---|---|
| | Solid electrolyte | Li | a | A | b | E | c | J | e | X | f | H | h |
| Example 1 | Li₄Zr_{0.25}(SO₄)₂Cl | Li | 4 | — | 0 | Zr | 0.25 | SO₄ | 2 | Cl | 1 | — | 0 |
| Example 2 | Li₆Zr_{0.5}(SO₄)₃Cl₂ | Li | 6 | — | 0 | Zr | 0.5 | SO₄ | 3 | Cl | 2 | — | 0 |
| Example 3 | Li₄Zr(SO₄)₂Cl₄ | Li | 4 | — | 0 | Zr | 1 | SO₄ | 2 | Cl | 4 | — | 0 |
| Example 4 | Li₂Zr(SO₄)Cl₄ | Li | 2 | — | 0 | Zr | 1 | SO₄ | 1 | Cl | 4 | — | 0 |
| Example 5 | LiZr(SO₄)_{0.5}Cl₄ | Li | 1 | — | 0 | Zr | 1 | SO₄ | 0.5 | Cl | 4 | — | 0 |
| Example 6 | Li_{0.5}Zr(SO₄)_{0.25}Cl₄ | Li | 0.5 | — | 0 | Zr | 1 | SO₄ | 0.25 | Cl | 4 | — | 0 |
| Example 7 | Li_{1.2}Zr(SO₄)_{2.1}Cl | Li | 1.2 | — | 0 | Zr | 1 | SO₄ | 2.1 | Cl | 1 | — | 0 |
| Example 8 | Li_{0.6}Zr(SO₄)_{2.05}Cl_{0.5} | Li | 0.6 | — | 0 | Zr | 1 | SO₄ | 2.05 | Cl | 1 | — | 0 |
| Example 9 | Li₂Zr_{1.5}(SO₄)₂Cl₄ | Li | 2 | — | 0 | Zr | 1.5 | SO₄ | 2 | Cl | 4 | — | 0 |
| Example 10 | Li₂Zr_{1.9}(SO₄)_{1.8}Cl₆ | Li | 2 | — | 0 | Zr | 1.9 | SO₄ | 1.8 | Cl | 6 | — | 0 |
| Example 11 | Li_{1.2}Na_{0.8}Zr(SO₄)Cl₄ | Li | 1.2 | Na | 0.8 | Zr | 1 | SO₄ | 2 | Cl | 4 | — | 0 |
| Example 12 | Li_{1.4}K_{0.6}Zr(SO₄)Cl₄ | Li | 1.4 | K | 0.6 | Zr | 1 | SO₄ | 2 | Cl | 4 | — | 0 |
| Example 13 | Li_{1.6}Rb_{0.4}Zr(SO₄)Cl₄ | Li | 1.6 | Rb | 0.4 | Zr | 1 | SO₄ | 2 | Cl | 4 | — | 0 |
| Example 14 | Li_{1.8}Cs_{0.2}Zr(SO₄)Cl₄ | Li | 1.8 | Cs | 0.2 | Zr | 1 | SO₄ | 1 | Cl | 4 | — | 0 |
| Example 15 | Li₂Zr_{0.8}Al_{0.2}(SO₄)Cl_{3.8} | Li | 2 | — | 0 | Zr/Al | 0.8/0.2(1) | SO₄ | 1 | Cl | 3.8 | — | 0 |
| Example 16 | Li₂Zr_{0.8}Ga_{0.2}(SO₄)Cl_{3.8} | Li | 2 | — | 0 | Zr/Ga | 0.8/0.2(1) | SO₄ | 1 | Cl | 3.8 | — | 0 |
| Example 17 | Li₂Zr_{0.8}In_{0.2}(SO₄)Cl_{3.8} | Li | 2 | — | 0 | Zr/In | 0.8/0.2(1) | SO₄ | 1 | Cl | 3.8 | — | 0 |
| Example 18 | Li₂Zr_{0.8}Sc_{0.2}(SO₄)Cl_{3.8} | Li | 2 | — | 0 | Zr/Sc | 0.8/0.2(1) | SO₄ | 1 | Cl | 3.8 | — | 0 |
| Example 19 | Li₂Zr_{0.8}Y_{0.2}(SO₄)Cl_{3.8} | Li | 2 | — | 0 | Zr/Y | 0.8/0.2(1) | SO₄ | 1 | Cl | 3.8 | — | 0 |
| Example 20 | Li₂Zr_{0.8}Ti_{0.2}(SO₄)Cl₄ | Li | 2 | — | 0 | Zr/Ti | 0.8/0.2(1) | SO₄ | 1 | Cl | 3.8 | — | 0 |
| Example 21 | Li₂Zr_{0.9}Hf_{0.1}(SO₄)Cl₄ | Li | 2 | — | 0 | Zr/Hf | 0.9/0.1(1) | SO₄ | 1 | Cl | 3.8 | — | 0 |

TABLE 2

| | Raw materials | | | Mole ratio | | | Synthesis |
|---|---|---|---|---|---|---|---|
| | Substance A | Substance B | Substance C | Substance A | Substance B | Substance C | time [h] |
| Example 1 | Li₂SO₄ | ZrCl₄ | | 8 | 1 | | 2.5 |
| Example 2 | Li₂SO₄ | ZrCl₄ | | 6 | 1 | | 3.5 |
| Example 3 | Li₂SO₄ | ZrCl₄ | | 2 | 1 | | 4.5 |
| Example 4 | Li₂SO₄ | ZrCl₄ | | 1 | 1 | | 5.5 |
| Example 5 | Li₂SO₄ | ZrCl₄ | | 1 | 2 | | 6.5 |
| Example 6 | Li₂SO₄ | ZrCl₄ | | 1 | 4 | | 7.5 |
| Example 7 | Zr(SO₄)₂ | Li₂SO₄ | LiCl | 1 | 0.1 | 1 | 8.5 |
| Example 8 | Zr(SO₄)₂ | Li₂SO₄ | LiCl | 1 | 0.05 | 0.5 | 8.5 |
| Example 9 | Zr(SO₄)₂ | Li₂SO₄ | ZrCl₄ | 0.5 | 1 | 1 | 5 |
| Example 10 | Zr(SO₄)₂ | Li₂SO₄ | ZrCl₄ | 0.4 | 1 | 1.5 | 5 |
| Example 11 | Li₂SO₄ | Na₂SO₄ | ZrCl₄ | 0.6 | 0.4 | 1 | 5 |
| Example 12 | Li₂SO₄ | K₂SO₄ | ZrCl₄ | 0.7 | 0.3 | 1 | 5 |
| Example 13 | Li₂SO₄ | Rb₂SO₄ | ZrCl₄ | 0.8 | 0.2 | 1 | 5 |
| Example 14 | Li₂SO₄ | Cs₂SO₄ | ZrCl₄ | 0.9 | 0.1 | 1 | 5 |
| Example 15 | Li₂SO₄ | AlCl₃ | ZrCl₄ | 1 | 0.2 | 0.8 | 5 |
| Example 16 | Li₂SO₄ | GaCl₃ | ZrCl₄ | 1 | 0.2 | 0.8 | 5 |
| Example 17 | Li₂SO₄ | InCl₃ | ZrCl₄ | 1 | 0.2 | 0.8 | 5 |
| Example 18 | Li₂SO₄ | ScCl₃ | ZrCl₄ | 1 | 0.2 | 0.8 | 5 |
| Example 19 | Li₂SO₄ | YCl₃ | ZrCl₄ | 1 | 0.2 | 0.8 | 5 |
| Example 20 | Li₂SO₄ | TiCl₄ | ZrCl₄ | 1 | 0.2 | 0.8 | 5 |
| Example 21 | Li₂SO₄ | HfCl₄ | ZrCl₄ | 1 | 0.1 | 0.8 | 5 |

TABLE 3

| | | LiₐA_{b}E_{c}J_{c}X_{f}Hₕ | | | | | | | | | | | |
|---|---|---|---|---|---|---|---|---|---|---|---|---|---|
| | Solid electrolyte | Li | a | A | b | E | c | J | e | X | f | H | h |
| Example 22 | Li₁₀ZrO₅Cl₄ | Li | 10 | | 0 | Zr | 1 | O | 5 | Cl | 4 | — | 0 |
| Example 23 | Li₆ZrO₃Cl₄ | Li | 6 | | 0 | Zr | 1 | O | 3 | Cl | 4 | — | 0 |
| Example 24 | Li₄ZrO₂Cl₄ | Li | 4 | | 0 | Zr | 1 | O | 2 | Cl | 4 | — | 0 |
| Example 25 | Li₂ZrOCl₄ | Li | 2 | | 0 | Zr | 1 | O | 1 | Cl | 4 | — | 0 |
| Example 26 | LiZrO_{0.5}Cl₄ | Li | 1 | | 0 | Zr | 1 | O | 0.5 | Cl | 4 | — | 0 |
| Example 27 | Li_{2.5}ZrOCl_{4.5} | Li | 2.5 | | 0 | Zr | 1 | O | 1 | Cl | 4.5 | — | 0 |
| Example 28 | Li_{2.5}ZrOCl₄I_{0.5} | Li | 2.5 | | 0 | Zr | 1 | O | 1 | Cl/I | 4/0.5 | — | 0 |
| Example 29 | Li_{2.5}ZrOCl₄Br_{0.5} | Li | 2.5 | | 0 | Zr | 1 | O | 1 | Cl/Br | 4/0.5 | — | 0 |
| Example 30 | Li_{2.5}ZrOCl₄F_{0.5} | Li | 2.5 | | 0 | Zr | 1 | O | 1 | Cl/F | 4/0.5 | — | 0 |
| Example 31 | Li₂ZrO_{0.1}(SO₄)Cl₄H_{0.2} | Li | 2 | | 0 | Zr | 1 | O | 0.1 | Cl | 4 | H | 0.2 |
| Example 32 | Li₂ZrO_{0.025}(SO₄)Cl₄H_{0.05} | Li | 2 | | 0 | Zr | 1 | O | 0.025 | Cl | 4 | H | 0.05 |
| Example 33 | Li_{1.5}Zr(PO₄)_{0.5}Cl₄ | Li | 1.5 | | 0 | Zr | 1 | PO₄ | 0.5 | Cl | 4 | — | 0 |

TABLE 4

| | Raw materials | | | Mole ratio | | | Synthesis |
|---|---|---|---|---|---|---|---|
| | Substance A | Substance B | Substance C | Substance A | Substance B | Substance C | time [h] |
| Example 22 | Li₂O | ZrCl₄ | | 5 | 1 | | 4 |
| Example 23 | Li₂O | ZrCl₄ | | 3 | 1 | | 6 |
| Example 24 | Li₂O | ZrCl₄ | | 2 | 1 | | 24 |
| Example 25 | Li₂O | ZrCl₄ | | 1 | 1 | | 48 |
| Example 26 | Li₂O | ZrCl₄ | | 0.5 | 1 | | 72 |
| Example 27 | Li₂O | LiCl | ZrCl₄ | 1 | 0.5 | 1 | 48 |
| Example 28 | Li₂O | LiI | ZrCl₄ | 1 | 0.5 | 1 | 48 |
| Example 29 | Li₂O | LiBr | ZrCl₄ | 1 | 0.5 | 1 | 48 |
| Example 30 | Li₂O | LiF | ZrCl₄ | 1 | 0.5 | 1 | 48 |
| Example 31 | H₂O | Li₂SO₄ | ZrCl₄ | 0.1 | 1 | 1 | 5 |
| Example 32 | H₂O | Li₂SO₄ | ZrCl₄ | 0.025 | 1 | 1 | 5 |
| Example 33 | Li₃PO₄ | ZrCl₄ | | 0.5 | 1 | | 48 |

TABLE 5

| | | LiₐA_{b}E_{c}J_{c}X_{f}Hₕ | | | | | | | | | | | |
|---|---|---|---|---|---|---|---|---|---|---|---|---|---|
| | Solid electrolyte | Li | a | A | b | E | C | J | e | X | f | H | h |
| Comparative Example 1 | Li₂ZrCl₆ | Li | 2 | — | 0 | Zr | 1 | — | 0 | Cl | 6 | — | 0 |
| Comparative Example 2 | Li₂Zr(SO₄)Cl₄ | Li | 2 | — | 0 | Zr | 1 | SO₄ | 0 | Cl | 4 | — | 0 |
| Comparative Example 3 | Li₂ZrO_{0.25}(SO₄)Cl₄H_{0.5} | Li | 2 | — | 0 | Zr | 1 | O | 0.25 | Cl | 4 | H | 0.5 |
| Comparative Example 4 | Li₂Zr(SO₄)Cl₄ | Li | 2 | — | 0 | Zr | 1 | SO₄ | 0 | Cl | 4 | — | 0 |
| Comparative Example 5 | Li₂Zr(SO₄)Cl₄ | Li | 2 | — | 0 | Zr | 1 | SO₄ | 0 | Cl | 4 | — | 0 |
| Comparative Example 6 | Li₂Zr_{0.8}In_{0.2}(SO₄)Cl_{3.8} | Li | 2 | — | 0 | Zr/In | 0.8/0.2(1) | SO₄ | 1 | Cl | 3.8 | — | 0 |
| Comparative Example 7 | Li₂Zr_{0.8}Sc_{0.2}(SO₄)Cl_{3.8} | Li | 2 | — | 0 | Zr/Sc | 0.8/0.2(1) | SO₄ | 1 | Cl | 3.8 | — | 0 |
| Comparative Example 8 | Li₆ZrO₃Cl₄ | Li | 6 | — | 0 | Zr | 1 | O | 3 | Cl | 4 | — | 0 |
| Comparative Example 9 | Li₄ZrO₂Cl₄ | Li | 4 | — | 0 | Zr | 1 | O | 2 | Cl | 4 | — | 0 |
| Comparative Example 10 | Li₂ZrOCl₄ | Li | 2 | — | 0 | Zr | 1 | O | 1 | Cl | 4 | — | 0 |
| Comparative Example 11 | LiZrO_{0.5}Cl₄ | Li | 1 | | 0 | Zr | 1 | O | 0.5 | Cl | 4 | — | 0 |
| Comparative Example 12 | Li_{2.5}ZrOCl_{4.5} | Li | 2.5 | — | 0 | Zr | 1 | O | 1 | Cl | 4.5 | — | 0 |
| Comparative Example 13 | Li_{1.5}Zr(PO₄)_{0.5}Cl₄ | Li | 1.5 | — | 0 | Zr | 1 | PO₄ | 0.5 | Cl | 4 | — | 0 |

TABLE 6

| | Raw materials | | | Mole ratio | | | Synthesis |
|---|---|---|---|---|---|---|---|
| | Substance A | Substance B | Substance C | Substance A | Substance B | Substance C | time [h] |
| Comparative Example 1 | LiCl | ZrCl₄ | | 2 | 1 | | 24 |
| Comparative Example 2 | Li₂SO₄ | ZrCl₄ | | 1 | 1 | | 24 |
| Comparative Example 3 | H₂O | Li₂SO₄ | ZrCl₄ | 0.25 | 1 | 1 | 5.5 |
| Comparative Example 4 | Li₂SO₄ | ZrCl₄ | | 1 | 1 | | 5.5 |
| Comparative Example 5 | Li₂SO₄ | ZrCl₄ | | 1 | 1 | | 24 |
| Comparative Example 6 | Li₂SO₄ | InCl₃ | ZrCl₄ | 1 | 0.2 | 0.8 | 5 |
| Comparative Example 7 | Li₂SO₄ | ScCl₃ | ZrCl₄ | 1 | 0.2 | 0.8 | 24 |
| Comparative Example 8 | Li₂O | ZrCl₄ | | 3 | 1 | | 24 |
| Comparative Example 9 | Li₂O | ZrCl₄ | | 2 | 1 | | 48 |
| Comparative Example 10 | Li₂O | ZrCl₄ | | 1 | 1 | | 48 |
| Comparative Example 11 | Li₂O | ZrCl₄ | | 0.5 | 1 | | 72 |
| Comparative Example 12 | Li₂O | LiCl | ZrCl₄ | 1 | 0.5 | 1 | 96 |
| Comparative Example 13 | Li₃PO₄ | ZrCl₄ | | 0.5 | 1 | | 72 |

TABLE 7

| | | Raman shift 200 to 450 | | | | Raman shift 80 to 200 | | | | |
|---|---|---|---|---|---|---|---|---|---|---|
| | | [cm⁻¹] | | | | [cm⁻¹] | | | | Rate |
| | | Strongest | | Half | | Strongest | | Half | Ion | characteristics |
| | | peak | | width | | peak | | width | conductivity | (1 C/0.1 C) |
| | Solid electrolyte | [cm⁻¹] | IC/IA | [cm⁻¹] | IC | [cm⁻¹] | IC/IB | [cm⁻¹] | [S/cm] | [%] |
| Example 1 | Li₄Zr_{0.25}(SO₄)₂Cl | 345 | 0.20 | 89 | 0.15 | 141 | 0.15 | 83 | 1.1E−03 | 70 |
| Example 2 | Li₆Zr_{0.5}(SO₄)₃Cl₂ | 354 | 0.22 | 97 | 0.15 | 134 | 0.15 | 84 | 1.3E−03 | 72 |
| Example 3 | Li₄Zr(SO₄)₂Cl₄ | 368 | 0.24 | 111 | 0.16 | 128 | 0.16 | 84 | 1.5E−03 | 75 |
| Example 4 | Li₂Zr(SO₄)Cl₄ | 376 | 0.28 | 126 | 0.17 | 120 | 0.16 | 86 | 2.3E−03 | 80 |
| Example 5 | LiZr(SO₄)_{0.5}Cl₄ | 372 | 0.26 | 115 | 0.17 | 122 | 0.16 | 85 | 2.0E−03 | 78 |
| Example 6 | Li_{0.5}Zr(SO₄)_{0.25}Cl₄ | 358 | 0.25 | 103 | 0.16 | 130 | 0.16 | 83 | 1.5E−03 | 76 |
| Example 7 | Li_{1.2}Zr(SO₄)_{2.1}Cl | 336 | 0.34 | 85 | 0.14 | 143 | 0.21 | 75 | 8.0E−04 | 67 |
| Example 8 | Li_{0.6}Zr(SO₄)_{2.05}Cl_{0.5} | 335 | 0.41 | 81 | 0.13 | 144 | 0.32 | 72 | 8.5E−03 | 67 |
| Example 9 | Li₂Zr_{1.5}(SO₄)₂Cl₄ | 336 | 0.31 | 91 | 0.14 | 138 | 0.21 | 78 | 9.2E−03 | 68 |
| Example 10 | Li₂Zr_{1.9}(SO₄)_{1.8}Cl₆ | 334 | 0.33 | 95 | 0.15 | 141 | 0.24 | 80 | 9.4E−04 | 69 |
| Example 11 | Li_{1.2}Na_{0.8}Zr(SO₄)Cl₄ | 373 | 0.28 | 122 | 0.18 | 118 | 0.17 | 93 | 1.8E−03 | 77 |
| Example 12 | Li_{1.4}K_{0.6}Zr(SO₄)Cl₄ | 371 | 0.30 | 119 | 0.17 | 115 | 0.16 | 91 | 1.5E−03 | 75 |
| Example 13 | Li_{1.6}Rb_{0.4}Zr(SO₄)Cl₄ | 369 | 0.30 | 115 | 0.17 | 114 | 0.16 | 89 | 1.4E−03 | 74 |
| Example 14 | Li_{1.8}Cs_{0.2}Zr(SO₄)Cl₄ | 365 | 0.33 | 110 | 0.17 | 112 | 0.16 | 86 | 1.2E−03 | 73 |
| Example 15 | Li₂Zr_{0.8}Al_{0.2}(SO₄)Cl_{3.8} | 381 | 0.30 | 124 | 0.15 | 121 | 0.18 | 84 | 2.2E−03 | 79 |
| Example 16 | Li₂Zr_{0.8}Ga_{0.2}(SO₄)Cl_{3.8} | 380 | 0.27 | 124 | 0.16 | 120 | 0.17 | 84 | 2.2E−03 | 80 |
| Example 17 | Li₂Zr_{0.8}In_{0.2}(SO₄)Cl_{3.8} | 378 | 0.25 | 125 | 0.17 | 119 | 0.17 | 86 | 2.5E−03 | 82 |

TABLE 8

| | | Raman shift 200 to 450 | | | | Raman shift 80 to 200 | | | | |
|---|---|---|---|---|---|---|---|---|---|---|
| | | [cm⁻¹] | | | | [cm⁻¹] | | | | Rate |
| | | Strongest | | Half | | Strongest | | Half | Ion | characteristics |
| | | peak | | width | | peak | | width | conductivity | (1 C/0.1 C) |
| | Solid electrolyte | [cm⁻¹] | IC/IA | [cm⁻¹] | IC | [cm⁻¹] | IC/IB | [cm⁻¹] | [S/cm] | [%] |
| Example 18 | Li₂Zr_{0.8}Sc_{0.2}(SO₄)Cl_{3.8} | 376 | 0.21 | 126 | 0.17 | 117 | 0.15 | 87 | 2.7E−03 | 84 |
| Example 19 | Li₂Zr_{0.8}Y_{0.2}(SO₄)Cl_{3.8} | 377 | 0.27 | 125 | 0.16 | 120 | 0.15 | 84 | 1.5E−03 | 75 |
| Example 20 | Li₂Zr_{0.8}Ti_{0.2}(SO₄)Cl₄ | 380 | 0.28 | 124 | 0.15 | 121 | 0.14 | 84 | 1.4E−03 | 74 |
| Example 21 | Li₂Zr_{0.9}Hf_{0.1}(SO₄)Cl₄ | 374 | 0.22 | 125 | 0.18 | 118 | 0.16 | 87 | 2.1E−03 | 78 |
| Example 22 | Li₁₀ZrO₅Cl₄ | 327 | 0.60 | 74 | 0.28 | 97 | 0.14 | 67 | 8.9E−04 | 68 |
| Example 23 | Li₆ZrO₃Cl₄ | 329 | 0.58 | 77 | 0.29 | 99 | 0.25 | 71 | 9.5E−04 | 69 |
| Example 24 | Li₄ZrO₂Cl₄ | 330 | 0.55 | 79 | 0.29 | 102 | 0.31 | 84 | 2.6E−03 | 83 |
| Example 25 | Li₂ZrOCl₄ | 332 | 0.52 | 80 | 0.30 | 106 | 0.33 | 92 | 3.2E−03 | 86 |
| Example 26 | LiZrO_{0.5}Cl₄ | 330 | 0.56 | 78 | 0.30 | 100 | 0.3 | 83 | 2.3E−03 | 80 |
| Example 27 | Li_{2.5}ZrOCl_{4.5} | 331 | 0.53 | 82 | 0.28 | 107 | 0.41 | 92 | 2.5E−03 | 82 |
| Example 28 | Li_{2.5}ZrOCl₄I_{0.5} | 322 | 0.50 | 82 | 0.22 | 98 | 0.36 | 90 | 2.1E−03 | 80 |
| Example 29 | Li_{2.5}ZrOCl₄Br_{0.5} | 334 | 0.51 | 83 | 0.31 | 104 | 0.39 | 90 | 2.3E−03 | 81 |
| Example 30 | Li_{2.5}ZrOCl₄F_{0.5} | 325 | 0.54 | 79 | 0.26 | 118 | 0.44 | 88 | 1.8E−03 | 79 |
| Example 31 | Li₂ZrO_{0.1}(SO₄)Cl₄H_{0.2} | 334 | 0.12 | 65 | 0.11 | 150 | 0.11 | 70 | 9.1E−04 | 68 |
| Example 32 | Li₂ZrO_{0.025}(SO₄)Cl₄H_{0.05} | 350 | 0.15 | 80 | 0.12 | 132 | 0.14 | 85 | 2.2E−03 | 79 |
| Example 33 | Li_{1.5}Zr(PO₄)_{0.5}Cl₄ | 335 | 0.45 | 72 | 0.27 | 104 | 0.27 | 91 | 2.5E−03 | 83 |

TABLE 9

| | | Raman shift 200 to 450 | | | | Raman shift 80 to 200 | | | | |
|---|---|---|---|---|---|---|---|---|---|---|
| | | [cm⁻¹] | | | | [cm⁻¹] | | | | Rate |
| | | Strongest | | Half | | Strongest | | Half | Ion | characteristics |
| | | peak | | width | | peak | | width | conductivity | (1 C/0.1 C) |
| | Solid electrolyte | [cm⁻¹] | IC/IA | [cm⁻¹] | IC | [cm⁻¹] | IC/IB | [cm⁻¹] | [S/cm] | [%] |
| Comparative Example 1 | Li₂ZrCl₆ | 327 | 0.05 | 20 | 0.07 | 158 | 0.078 | 43 | 3.2E−04 | 15 |
| Comparative Example 2 | Li₂Zr(SO₄)Cl₄ | 329 | 0.09 | 53 | 0.07 | 147 | 0.073 | 65 | 4.0E−04 | 30 |
| Comparative Example 3 | Li₂ZrO_{0.25}(SO₄)Cl₄H_{0.5} | 330 | 0.15 | 42 | 0.10 | 160 | 0.16 | 64 | 8.5E−04 | 51 |
| Comparative Example 4 | Li₂Zr(SO₄)Cl₄ | 335 | 0.19 | 54 | 0.11 | 158 | 0.18 | 65 | 8.9E−04 | 54 |
| Comparative Example 5 | Li₂Zr(SO₄)Cl₄ | 331 | 0.12 | 53 | 0.08 | 143 | 0.089 | 53 | 6.3E−04 | 43 |
| Comparative Example 6 | Li₂Zr_{0.8}In_{0.2}(SO₄)Cl_{3.8} | 343 | 0.18 | 53 | 0.10 | 155 | 0.16 | 64 | 9.2E−04 | 58 |
| Comparative Example 7 | Li₂Zr_{0.8}Sc_{0.2}(SO₄)Cl_{3.8} | 356 | 0.19 | 54 | 0.12 | 160 | 0.16 | 57 | 9.5E−04 | 62 |
| Comparative Example 8 | Li₆ZrO₃Cl₄ | 330 | 0.11 | 48 | 0.08 | 155 | 0.075 | 58 | 5.6E−04 | 39 |
| Comparative Example 9 | Li₄ZrO₂Cl₄ | 329 | 0.16 | 52 | 0.08 | 149 | 0.21 | 61 | 7.7E−04 | 47 |
| Comparative Example 10 | Li₂ZrOCl₄ | 331 | 0.19 | 49 | 0.13 | 141 | 0.28 | 65 | 9.8E−04 | 67 |
| Comparative Example 11 | LiZrO_{0.5}Cl₄ | 330 | 0.18 | 42 | 0.11 | 157 | 0.22 | 62 | 8.2E−04 | 55 |
| Comparative Example 12 | Li_{2.5}ZrOCl_{4.5} | 332 | 0.11 | 38 | 0.07 | 166 | 0.081 | 61 | 5.8E−04 | 49 |
| Comparative Example 13 | Li_{1.5}Zr(PO₄)_{0.5}Cl₄ | 333 | 0.09 | 36 | 0.27 | 104 | 0.27 | 91 | 4.9E−04 | 35 |

### (Production of All-Solid-State Battery)

An all-solid-state battery was produced in a glove box having a dew point of approximately −70 °C. The all-solid-state battery was produced using a pellet production jig. The pellet production jig included a PEEK (polyether ether ketone) holder having an inner diameter of 10 mm and an upper punch and a lower punch each having a diameter of 9.99 mm. The material of the upper and lower punches was a die steel (SKD 11 material).

The lower punch was inserted into the PEEK holder of the pellet production jig, and 50 mg of the solid electrolyte was charged onto the lower punch. Next, the resin holder was vibrated to level the surface of the solid electrolyte. Next, the upper punch was inserted onto the solid electrolyte, and the solid electrolyte was pressed at a load of approximately 4 kN using a pressing machine.

Next, the lower punch was removed, and 10 mg of a negative electrode mixture was charged onto the solid electrolyte. Next, the PEEK holder was vibrated to level the surface of the negative electrode mixture. Next, the lower punch was inserted onto the negative electrode mixture, and the negative electrode mixture was pressed at a load of 3 kN using the pressing machine. The negative electrode mixture was composed of a negative electrode active material and the above-described solid electrolyte, and lithium titanate (LTO) having an average particle diameter of 6.0 m was used as the negative electrode active material. Next, the upper punch was removed, and 10 mg of a positive electrode mixture was charged onto the solid electrolyte layer. Next, the PEEK holder was vibrated to level the surface of the positive electrode mixture. Next, the upper punch was inserted onto the positive electrode mixture, and the positive electrode mixture was pressed at a load of 3 kN using the pressing machine. The positive electrode mixture was composed of a positive electrode active material, carbon as a conductive assistant, and the above-described solid electrolyte, and lithium cobalt oxide (LCO) having an average particle diameter of 7.5 m was used as the positive electrode active material. An all-solid-state battery including a negative electrode mixture layer, a solid electrolyte layer, and a positive electrode mixture layer laminated in order was produced as described above.

In addition, two stainless steel plates having a diameter of 50 mm and a thickness of 5 mm and two BAKELITE (registered trademark) plates having a diameter of 50 mm and a thickness of 2 mm were prepared. Next, four holes through which screws were to be passed were provided in each of the two stainless steel plates and the two BAKELITE (registered trademark) plates. The holes through which screws were to be passed were provided at positions at which, when an electrochemical cell, the two stainless steel plates, and the two BAKELITE (registered trademark) plates were laminated together, the two stainless steel plates and the two BAKELITE (registered trademark) plates overlapped one another in a plan view but did not overlap the electrochemical cell in a plan view.

After that, the stainless steel plate, the BAKELITE (registered trademark) plate, the all-solid-state battery, the BAKELITE (registered trademark) plate, and the stainless steel plate were laminated in this order and fastened at a torque of 1 N·m by putting screws into the screw holes. An all-solid-state battery in which the upper punch and the lower punch of the electrochemical cell were insulated with the BAKELITE (registered trademark) plates was obtained as described above. Next, the all-solid-state battery was left to stand in a constant-temperature bath at 25 °C. for 48 hours to stabilize the open circuit voltage.

The rate characteristics were evaluated using the produced all-solid-state battery. The rate characteristics were evaluated from the ratio (0.1 C/1 C rate characteristics) of the discharge capacity when the all-solid-state battery was discharged at a discharge rate of 1 C to the discharge capacity at a discharge rate of 0.1 C. Constant current charging (CC charging) was performed on the all-solid-state battery in an environment of 25 °C at a 0.1 C rate constant current until a battery voltage of 2.7 V was reached. Next, after 2.7 V was reached, the all-solid-state battery was charged until the current became equivalent to 0.05 C (CV charging). After that, the all-solid-state battery was discharged at a 0.1 C rate constant current until a battery voltage of 1.5V was reached (CC charging), and the discharge capacity at 0.1 C was measured. Next, the all-solid-state battery was charged again under the above-described conditions, discharged at a 1 C discharge rate until a battery voltage of 1.5V was reached, and the discharge capacity at 1 C was measured. The measurement results are summarized in Tables 7 to 9.

Between Example 4 and Comparative Example 2 and between Comparative Example 4 and Comparative Example 5, the compositions were the same, but the conditions of the synthesis step were different. In Example 4, the cooling of the zirconia container for one hour from the beginning of the synthesis was performed, and the synthesis time was 5.5 hours. In contrast, in Comparative Example 2, the cooling of the zirconia container for one hour from the beginning of the synthesis was not performed, and the synthesis time was 24 hours, which was longer than that in Example 4. In addition, in Comparative Example 4, the cooling of the zirconia container for one hour from the beginning of the synthesis was not performed as was the case with Comparative Example 2, but the synthesis time was 5.5 hours as was the case with Example 4. In addition, in Comparative Example 5, the cooling of the zirconia container for one hour from the beginning of the synthesis was performed as was the case with Example 4, but the synthesis time was 24 hours, which was longer than that in Example 4. Depending on these differences in the conditions of the synthesis step, the ion conductivities of Example 4, Comparative Example 2, Comparative Example 4, and Comparative Example 5 were 2.3×10⁻³ [S/cm], 4.0×10⁻⁴ [S/cm], 8.9×10⁻⁴ [S/cm], and 6.3×10⁻⁴ [S/cm], respectively. In addition, according to these magnitudes of the ion conductivities, the rate characteristics of Example 4, Comparative Example 2, Comparative Example 4, and Comparative Example 5 were 80%, 30%, 54%, and 43%, respectively.

As described above, the ion conductivity could be improved by adjusting the conditions of the synthesis step in spite of the same composition, and consequently, the rate characteristics could also be improved.

In Example 4, cooling immediately after the beginning of the synthesis was performed, and the length of the synthesis time was optimized. In Comparative Example 2, cooling immediately after the beginning of the synthesis was not performed, and the length of the synthesis time was not optimized. The ion conductivity in Example 4 was 5.8 times the ion conductivity in Comparative Example 2. In addition, in Comparative Example 4, the length of the synthesis time was optimized, but cooling immediately after the beginning of the synthesis was not performed. The ion conductivity in Example 4 was 2.6 times the ion conductivity in Comparative Example 4. In addition, in Comparative Example 5, cooling immediately after the beginning of the synthesis was performed, but the length of the synthesis time was not optimized. The ion conductivity in Example 4 was 3.7 times the ion conductivity in Comparative Example 5.

Between Example 17 and Comparative Example 6, the compositions were the same, but the condition of the synthesis step was different. In Example 17, the cooling of the zirconia container for one hour from the beginning of the synthesis was performed. In contrast, in Comparative Example 6, the cooling of the zirconia container for one hour from the beginning of the synthesis was not performed.

Depending on this difference in the condition of the synthesis step, the ion conductivities of Example 17 and Comparative Example 6 were 2.5×10⁻³ [S/cm] and 9.2×10⁻⁴ [S/cm], respectively. In addition, according to these magnitudes of the ion conductivities, the rate characteristics of Example 17 and Comparative Example 6 were 82% and 58%, respectively.

As described above, the ion conductivity could be improved by adjusting the condition of the synthesis step in spite of the same composition, and consequently, the rate characteristics could also be improved.

The ion conductivity in Example 17 where the cooling of the zirconia container immediately after the beginning of the synthesis was performed was 2.7 times the ion conductivity in Comparative Example 6 where the cooling of the zirconia container immediately after the beginning of the synthesis was not performed.

Between Example 18 and Comparative Example 7, the compositions were the same, but the condition of the synthesis step was different. In Example 18, the synthesis time was five hours. In contrast, in Comparative Example 7, the synthesis time was 24 hours.

Depending on this difference in the condition of the synthesis step, the ion conductivities of Example 18 and Comparative Example 7 were 2.7×10⁻³ [S/cm] and 9.5×10⁻⁴ [S/cm], respectively. In addition, according to these magnitudes of the ion conductivities, the rate characteristics of Example 18 and Comparative Example 7 were 84% and 62%, respectively.

As described above, the ion conductivity could be improved by adjusting the condition of the synthesis step in spite of the same composition, and consequently, the rate characteristics could also be improved.

The ion conductivity in Example 18 where the length of the synthesis time was optimized was 2.8 times the ion conductivity in Comparative Example 7 where the length of the synthesis time was not optimized.

Between Example 23 and Comparative Example 8, the compositions were the same, but the condition of the synthesis step was different. In Example 23, the synthesis time was four hours. In contrast, in Comparative Example 8, the synthesis time was 24 hours.

Depending on this difference in the condition of the synthesis step, the ion conductivities of Example 23 and Comparative Example 8 were 9.5×10⁻⁴ [S/cm] and 5.6×10⁻⁴ [S/cm], respectively. In addition, according to these magnitudes of the ion conductivities, the rate characteristics of Example 23 and Comparative Example 8 were 69% and 39%, respectively.

As described above, the ion conductivity could be improved by adjusting the condition of the synthesis step in spite of the same composition, and consequently, the rate characteristics could also be improved.

The ion conductivity in Example 23 where the length of the synthesis time was optimized was 3.6 times the ion conductivity in Comparative Example 8 where the length of the synthesis time was not optimized.

Between Example 24 and Comparative Example 9, the compositions were the same, but the condition of the synthesis step was different. In Example 24, the synthesis time was four hours. In contrast, in Comparative Example 9, the synthesis time was 24 hours.

Depending on this difference in the condition of the synthesis step, the ion conductivities of Example 24 and Comparative Example 9 were 2.6×10⁻³ [S/cm] and 7.7×10⁻⁴ [S/cm], respectively. In addition, according to these magnitudes of the ion conductivities, the rate characteristics of Example 24 and Comparative Example 9 were 83% and 47%, respectively.

As described above, the ion conductivity could be improved by adjusting the condition of the synthesis step in spite of the same composition, and consequently, the rate characteristics could also be improved.

The ion conductivity in Example 24 where the length of the synthesis time was optimized was 3.4 times the ion conductivity in Comparative Example 9 where the length of the synthesis time was not optimized.

Between Example 25 and Comparative Example 10, the compositions were the same, but the condition of the synthesis step was different. In Example 25, the cooling of the zirconia container for one hour from the beginning of the synthesis was performed. In contrast, in Comparative Example 10, the cooling of the zirconia container for one hour from the beginning of the synthesis was not performed.

Depending on this difference in the condition of the synthesis step, the ion conductivities of Example 25 and Comparative Example 10 were 3.2×10⁻³ [S/cm] and 9.8×10⁻⁴ [S/cm], respectively. In addition, according to these magnitudes of the ion conductivities, the rate characteristics of Example 25 and Comparative Example 10 were 86% and 67%, respectively.

As described above, the ion conductivity could be improved by adjusting the condition of the synthesis step in spite of the same composition, and consequently, the rate characteristics could also be improved.

The ion conductivity in Example 25 where cooling immediately after the beginning of the synthesis was performed was 3.3 times the ion conductivity in Comparative Example 10 where cooling immediately after the beginning of the synthesis was not performed.

Between Example 26 and Comparative Example 11, the compositions were the same, but the condition of the synthesis step was different. In Example 26, the cooling of the zirconia container for one hour from the beginning of the synthesis was performed. In contrast, in Comparative Example 11, the cooling of the zirconia container for one hour from the beginning of the synthesis was not performed.

Depending on this difference in the condition of the synthesis step, the ion conductivities of Example 26 and Comparative Example 11 were 2.3×10⁻³ [S/cm] and 8.2×10⁻⁴ [S/cm], respectively. In addition, according to these magnitudes of the ion conductivities, the rate characteristics of Example 26 and Comparative Example 11 were 80% and 55%, respectively.

As described above, the ion conductivity could be improved by adjusting the condition of the synthesis step in spite of the same composition, and consequently, the rate characteristics could also be improved.

The ion conductivity in Example 26 where cooling immediately after the beginning of the synthesis was performed was 2.8 times the ion conductivity in Comparative Example 11 where cooling immediately after the beginning of the synthesis was not performed.

Between Example 27 and Comparative Example 12, the compositions were the same, but the condition of the synthesis step was different. In Example 27, the synthesis time was 48 hours. In contrast, in Comparative Example 12, the synthesis time was 96 hours.

Depending on this difference in the condition of the synthesis step, the ion conductivities of Example 27 and Comparative Example 12 were 2.5×10⁻³ [S/cm] and 5.8×10⁻⁴ [S/cm], respectively. In addition, according to these magnitudes of the ion conductivities, the rate characteristics of Example 27 and Comparative Example 12 were 82% and 49%, respectively.

As described above, the ion conductivity could be improved by adjusting the condition of the synthesis step in spite of the same composition, and consequently, the rate characteristics could also be improved.

The ion conductivity in Example 27 where the length of the synthesis time was optimized was 4.3 times the ion conductivity in Comparative Example 12 where the length of the synthesis time was not optimized.

Between Example 33 and Comparative Example 13, the compositions were the same, but the condition of the synthesis step was different. In Example 33, the synthesis time was 48 hours. In contrast, in Comparative Example 13, the synthesis time was 72 hours.

Depending on this difference in the condition of the synthesis step, the ion conductivities of Example 33 and Comparative Example 13 were 2.5×10⁻³ [S/cm] and 4.9×10⁻⁴ [S/cm], respectively. In addition, according to these magnitudes of the ion conductivities, the rate characteristics of Example 33 and Comparative Example 13 were 82% and 49%, respectively.

As described above, the ion conductivity could be improved by adjusting the condition of the synthesis step in spite of the same composition, and consequently, the rate characteristics could also be improved.

The ion conductivity in Example 33 where the length of the synthesis time was optimized was 4.3 times the ion conductivity in Comparative Example 13 where the length of the synthesis time was not optimized.

### INDUSTRIAL APPLICABILITY

The solid electrolyte of the present embodiment can be suitably applied to solid electrolyte batteries that serve as power supplies of electronic devices.

### REFERENCE SIGNS LIST

10 Solid electrolyte layer
20 Positive electrode
22 Positive electrode current collector
24 Positive electrode mixture layer
30 Negative electrode
32 Negative electrode current collector
34 Negative electrode mixture layer
40 Power generation element
50 Exterior body
52 Metal foil
54 Resin layer
60, 62 Terminal
100 Solid electrolyte battery

1-13. (canceled)

14. A method for manufacturing a solid electrolyte battery, the method comprising:
a step of weighing and mixing a raw material powder containing each element in a mole ratio that satisfies the following formula (1) and causing a mechanochemical reaction to synthesize the solid electrolyte,
wherein the solid electrolyte is synthesized while cooling is performed such that an amount of a temperature changed after one hour from a beginning of the synthesis reaches 10 °C or less,
LiₐA_{b}E_{c}JₑX_{f}H_{b} (1)
in the formula (1), A is at least one element selected from alkali metals other than Li and alkaline earth metals, E is at least one element selected from the group consisting of Al, Ga, In, Sc, Y, Ti, Zr, Hf, and lanthanoids, J is at least one group selected from the group consisting of anions, X is at least one element selected from the group consisting of F, Cl, Br, and I, 0.5≤a<6, 0≤b<6, 0<c<2, 0<e≤6, 0<f≤6.1, and 0≤h≤0.2.

15. The method for manufacturing a solid electrolyte according to claim 14,
wherein the raw material powder is mixed using a planetary ball mill; and thereby, the mechanochemical reaction is caused.

16. The method for manufacturing a solid electrolyte according to claim 15,
wherein a synthesis time is 2.5 hours to 72 hours.

17. The method for manufacturing a solid electrolyte according to claim 15,
wherein a rotation speed is set to 300 rpm, a revolution speed is set to 300 rpm, a rotation direction of rotation and a rotation direction of revolution are set to be opposite to each other, and the raw material powder is mixed using the planetary ball mill.

18. The method for manufacturing a solid electrolyte according to claim 15,
wherein the planetary ball mill includes zirconia balls, a zirconia airtight container, and a lid, the raw material powder and the zirconia balls are charged into the zirconia airtight container, next, the lid is fixed to the airtight container, a space between the airtight container and the lid is sealed with polyimide tape, and the raw material powder is mixed using the planetary ball mill in this state.

19. The method for manufacturing a solid electrolyte according to claim 18,
wherein work of weighing the raw material powder, work of charging the raw material powder and the zirconia balls into the airtight container, and work of fixing the lid to the airtight container and sealing the space between the airtight container and the lid with the polyimide tape are performed in an atmosphere where a dew point is −75 °C to −40 °C.

20. The method for manufacturing a solid electrolyte according to claim 14,
wherein the anion is at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH═CH—COO, C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, CH₃COO, and O, and BOB is bis(oxalate)borate, OOC—(CH₂)₂—COO is an anion of succinic acid, OOC—CH₂—COO is an anion of malonic acid, OOC—CH(OH)—CH(OH)—COO is an anion of tartaric acid, OOC—CH(OH)—CH₂—COO is an anion of malic acid, C₆H₅SO₃ is an anion of benzenesulfonic acid, OOC—CH═CH—COO (trans type) is an anion of fumaric acid, OOC—CH═CH—COO (cis type) is an anion of maleic acid, and C(OH)(CH₂COOH)₂COO is an anion of citric acid.
